(19) United States
(12) Patent Application Publication
(10) Pub. No.: US 2025/0087003 A1
(43) Pub. Date: Mar. 13, 2025

(54) CHARACTER STRING READING METHOD, CHARACTER STRING READING DEVICE, AND STORAGE MEDIUM

(71) Applicant: OPTOELECTRONICS CO., LTD., Warabi-shi (JP)

(72) Inventor: Takashi USHIKI, Warabi-shi (JP)

(21) Appl. No.: 18/665,908

(22) Filed: May 16, 2024

(30) Foreign Application Priority Data
Sep. 12, 2023 (JP) 2023-147753

(51) Int. Cl. G06V 30/19; G06V 30/12; G06V 30/14; G06V 30/146

(52) U.S. Cl. CPC G06V 30/1908; G06V 30/12; G06V 30/1444; G06V 30/1473; G06V 30/19153

(57) ABSTRACT

In a character string reading device, an imaging part obtains an image of a read object, and an output format setting part sets an output format of a character string to be read from the image and to be output. A character recognition condition setting part sets a character recognition condition, that only a group of characters including all characters defined by the output format are to be identified, among characters which the character string reading device can identify. A character string recognizing part recognizes a character string in the image according to the character recognition condition. A character extracting part obtains a character string for output, at a portion matching the output format among the recognized character string.

### FIELD

The present invention relates to a character string reading method of obtaining an image of a read object by an image obtaining part and reading a character string in the obtained image, a character string reading device configured to perform such character string reading, and a non-transitory machine-readable storage medium containing program instructions for causing a computer or computers to execute such character string reading method.

### BACKGROUND

Conventionally, an OCR (Optical Character Recognition) is used to read a character string included in a captured image. In addition, it is known to notify the operator of a possibility that a misreading has been occurred at the time of the reading.

For example, PTL1 discloses to store a plurality of read formats each defining an attribute of a character string, search a first read format matching a character string recognized in a character string recognition, search also a second read format with which the character string matching the first read format matches as a substring, and notify a possibility of misreading when such a second read format is found.

PTL2 discloses to, in a case where a group of character strings in which a plurality of character strings are arranged is read, and the characters included in different character strings are arranged so as to form rows along a direction orthogonal to the arrangement direction of the characters in the group, determine presence or absence of misrecognition according to calculation result of numbers of the characters of in the rows, and notify of information on the characters that has been erroneously recognized.

PTL3 discloses to notify, when the matching rate between a character image and a character template in character recognition falls within a predetermined range, report the recognition result of the character image as a possible misread character.

### CITATION LIST

### Patent Literature

[PTL1] Japanese Patent No. 6403417

[PTL2] Japanese Patent Application Laid-Open Publication No. 2020-24492

[PTL3] Japanese Patent No. 6524800

### SUMMARY

In particular, when a portable reading device is used, images of character strings to be read are captured in various environments. Therefore, the image is often not captured under an ideal condition, and there is a limit to accurate reading. Accordingly, it is preferable that when there is a possibility that misreading has occurred, the fact can be notified to the operator. This is because, even when misreading occurs, if the operator visually compares the object character string to be read with the read result, it is easy to find the misreading and it is also possible to correct the read result.

On the other hand, if the possibility of misreading is notified even when an accurate reading is performed, it gradually leads the operator to ignore the notification. Therefore, it is required to give the notification at an appropriate frequency.

It is also required to reduce incidence of misreading as much as possible. Of course, it is also required to reduce incidence of failure in reading itself.

The present invention has been made in view of such circumstances, and an object of the present invention is to improve accuracy of a character recognition on a captured image by simple and low-load process.

In order to achieve the above object, a character string reading method of the invention is a character string reading method of the invention capable of being executed by a character string reading device. The method comprises obtaining a first image of a read object by an image obtaining part. The method further comprises: obtaining a first format of a character string to be read from the first image and to be output; and setting, as a first character recognition condition, that only a first group of characters including all characters defined by the first format are to be identified, among characters which the character string reading device can identify. The method further comprises recognizing a first character string in the first image according to the first character recognition condition. The method further comprises obtaining, for output, a second character string at a portion matching the first format among the first character string.

In the above character string reading method, it is conceivable that the recognizing of the first character string comprises: recognizing first shapes included in the first image; and specifying a character candidate constituted by a combination of one or more shapes among the first shapes. The recognizing of the first character string may further comprise: identifying which character the character candidate is, based on a matching rate obtained by comparing characteristics of the specified character candidate with characteristics of each of the characters in the first group, and recognizing a character candidate which is not identified as any of the characters in the first group as an indefinite character; and recognizing the identified character and the indefinite character being arranged in a substantially straight line, as the first character string constituted of the arranged identified character and indefinite character.

Alternatively, in the above character string reading method, it is conceivable that in the obtaining of the second character string, in a case where a plurality of portions matching the first format are found in the first character string, a first portion with a highest matching rate with characteristics of characters in the recognizing of the first character string, among the plurality of portions, is obtained as the second character string.

Further, the method may further comprise notifying a possibility of misreading in the case where the plurality of portions matching the first format are found in the first character string.

Alternatively, in the above character string reading method, it is conceivable that in the obtaining of the second character string, in a case where a plurality of portions matching the first format are found in the first character string, a first portion including a center of the first image viewed in a direction of arrangement of characters in the first character string, among the plurality of portions, is obtained as the second character string.

Further, the method may further comprise notifying a possibility of misreading in the case where the plurality of portions matching the first format are found in the first character string.

In the above character string reading method, it is also conceivable that a plurality of first formats are obtained in the obtaining of the first format, the first group of characters regarding the first character recognition condition includes all characters defined by at least one format of the plurality of first formats. Further, the obtaining of the second character string may comprise obtaining a portion matching at least one format of the plurality of first formats among the first character string as a candidate of the second character string.

Further, it is conceivable that the obtaining of the second character string comprises: obtaining, among the obtained candidates of the second character string, a first candidate that matched the first format over a longest number of characters as the second character string.

In the above character string reading method, it is also conceivable that the first format can include a processing rule of a character string. Further, the method may further comprise: processing, in a case where the first format includes the processing rule, the second character string according to the processing rule, and outputting the processed character string.

According to the configuration of the present invention as described above, it is possible to improve accuracy of a character recognition on a captured image by simple and low-load process.

Further, the present invention further provides the following character string reading method. An object of the method is to enable to appropriately notify an operator of a possibility of misreading in a character recognition on a captured image by simple and low-load process.

In order to achieve the above object, a character string reading method of the invention comprises obtaining a first image of a read object by an image obtaining part. The method further comprises: obtaining one or more formats of a character string to be read from the first image and to be output. The method further comprises: recognizing a first character string in the first image; and obtaining, for output, a second character string at a portion matching a first format, the first format being one of the obtained one or more formats, among the first character string. The method further comprises notifying a possibility of misreading in a case where the second character string having characters less than a notification threshold number is obtained.

It is conceivable that the method further comprises configuring the notification threshold number based on a maximum number of characters in the character string defined by the obtained one or more formats.

Alternatively, it is conceivable that the method comprises configuring the notification threshold number to a maximum number of characters in the character string defined by the obtained one or more formats.

In the above character string reading method, it is also conceivable that at least one of the obtained one or more formats defines a character string partitioned into a plurality of sections. In this case, the notification threshold number may be configured for each of the plurality of sections, and the notifying of the possibility of misreading may be performed such that the possibility of misreading is notified in a case where the second character string having a first section among the plurality of sections, number of characters in the first section being less than the notification threshold number for the first section, is obtained.

Furthermore, it is conceivable that the method further comprises: configuring the notification threshold number for each of the plurality of sections based on a maximum number of characters in the section of the character string defined by the obtained one or more formats.

Alternatively, it is conceivable that the method comprises: configuring the notification threshold number for each of the plurality of sections to a maximum number of characters in the section of the character string defined by the obtained one or more formats.

The above character string reading method may be capable of being executed by a character string reading device. It is conceivable that such character string reading method comprise: setting, as a first character recognition condition, that only a first group of characters including all characters defined by at least one format of the obtained one or more formats are to be identified, among characters which the character string reading device can identify, and that the recognizing of the first character string is recognizing the first character string in the first image according to the first character recognition condition.

According to the configuration of the present invention as described above, it is possible to appropriately notify an operator of possibility of misreading in a character recognition on a captured image by simple and low-load process.

The present invention also provides the following character string reading method. An object of the method is to enable to appropriately notify an operator of possibility of misreading in a character recognition on a captured image.

In order to achieve the above object, a character string reading method of the invention comprises obtaining a first image of a read object by an image obtaining part. The method further comprises recognizing first shapes in the first image, and recognizing a first character string from among the recognized first shapes. The method further comprises notifying a possibility of misreading in a case where a second shape, among the first shapes, not constituting any character exists in or near the recognized first character string.

It is conceivable that the method further comprises obtaining, for output, a second character string that is all or a part of the first character string. In this case that the notifying of the possibility of misreading may be notifying the possibility of misreading in a case where the second shape not constituting any character exists in or near the second character string among the recognized first character string.

It is also conceivable that the recognizing of the first character string comprises determining a height of characters constituting the first character string, the height being a size in a first direction perpendicular to an arrangement direction of the characters. In this case, in the notifying, a shape having a size in the first direction smaller than a predetermined threshold compared to the height of the characters constituting the first character string, among the first shapes, may be ignored. Alternatively, in the notifying, a shape having a size in the first direction larger than a predetermined threshold compared to the height of the characters constituting the first character string, among the first shapes, may be ignored.

It is also conceivable that the recognizing of the first shapes comprises determining contrasts of the first shapes against background. In this case, in the notifying, a shape having a contrast against the background that differs by a predetermined threshold or more compared to those of shapes constituting the first character string, among the first shapes, may be ignored.

Alternatively, it is conceivable that the recognizing of the first shapes comprises determining sharpness of edges of the first shapes. In this case, in the notifying, a shape having a sharpness of an edge thereof that differs by a predetermined threshold or more compared to those of shapes constituting the first character string, among the first shapes, may be ignored.

It is also conceivable that, in the recognizing of the first character string, in addition to a character that can be identified, a character candidate that cannot be identified is also recognized as a character constituting the first character string. In this case, in the notifying, one or more character candidates consecutively arranged from an end of the first string may be considered to be shapes not constituting any character.

The above character string reading method may be capable of being executed by a character string reading device. It is conceivable that such character string reading method comprise: obtaining a first format of a character string to be read from the first image and to be output; and setting, as a first character recognition condition, that only a first group of characters including all characters defined by the first format are to be identified, among characters which the character string reading device can identify, and that the recognizing of the first character string is recognizing the first character string in the first image according to the first character recognition condition, and the obtaining of the second character string is obtaining a portion matching the first format among the first character string as the second character string.

Alternatively it is conceivable that the above character string reading method further comprising obtaining one or more formats of a character string to be read from the first image and to be output, and that the obtaining of the second character string is obtaining a portion matching a first format, the first format being one of the obtained one or more formats, among the first character string as the second character string, and in the notifying, the possibility of misreading is notified also in a case where the second character string having characters less than a notification threshold number is obtained.

Further, also such method may be capable of being executed by a character string reading device. It is conceivable that such character string reading method comprise: setting, as a first character recognition condition, that only a first group of characters including all characters defined by at least one format of the obtained one or more formats are to be identified, among characters which the character string reading device can identify, and that the recognizing of the first character string is recognizing the first character string in the first image according to the first character recognition condition.

According to the configuration of the present invention as described above, it is possible to appropriately notify an operator of possibility of misreading in a character recognition on a captured image.

In addition, the present invention can be implemented in any manner, such as a device, a system, a computer program, and a recording medium in which the computer program is recorded, in addition to the methods described above.

### BRIEF DESCRIPTION OF DRAWINGS

FIG. 1 is a block diagram illustrating a hardware configuration of a reading device 100 which is a first embodiment of the character string reading device of the present invention.

FIG. 2 is a functional block diagram illustrating a configuration of functions of the reading device 100 shown in FIG. 1.

FIG. 3 is a diagram illustrating examples of an output format used by the reading device shown in FIG. 1.

FIG. 4 is a flowchart of a process of reading characters executed by CPU 121 of the reading device 100.

FIG. 5 is a flowchart of the character recognition condition setting process shown in FIG. 4.

FIG. 6 is a flowchart of the character string recognizing process shown in FIG. 4.

FIG. 7 is a flowchart of the output character string extracting process shown in FIG. 4.

FIG. 8A to FIG. 8F are diagrams for explaining effects of the character recognition performed through the character string recognizing process of FIG. 6.

FIG. 9A to FIG. 9C are diagrams for explaining effects of the extraction of an output character string performed through the output character string extracting process of FIG. 7.

FIG. 10 is a functional block diagram corresponding to FIG. 2 illustrating a configuration of functions of the reading device 100 which is a second embodiment of the character string reading device of the present invention.

FIG. 11 is a flowchart of a process corresponding to FIG. 4 executed by CPU 121 of the reading device 100 of the second embodiment.

FIG. 12 is a flowchart of the character string recognizing process shown in FIG. 11.

FIG. 13A and FIG. 13B are diagrams for explaining notification of a possibility of misreading performed through the process of FIG. 11.

FIG. 14A and FIG. 14B are also diagrams for explaining notification of a possibility of misreading performed through the process of FIG. 11.

FIG. 15 is a functional block diagram corresponding to FIG. 2 illustrating a configuration of functions of the reading device 100 which is a third embodiment of the character string reading device of the present invention.

FIG. 16A to FIG. 16D are diagrams illustrating examples of shapes that do not constitute any character.

FIG. 17 is a flowchart of a process corresponding to FIG. 4 executed by CPU 121 of the reading device 100 of the third embodiment.

FIG. 18 is a flowchart of the anomalous shape searching process shown in FIG. 17.

FIG. 19A to FIG. 19D are diagrams for explaining notification of a possibility of misreading performed through the process of FIG. 17.

FIG. 20 is a functional block diagram corresponding to FIG. 2 illustrating a configuration of functions of the reading device 100 which is a fourth embodiment of the character string reading device of the present invention.

FIG. 21 is a flowchart of a process corresponding to FIG. 4 executed by CPU 121 of the reading device 100 of the fourth embodiment.

FIG. 22 is a flowchart of the output character string extracting process shown in FIG. 21.

FIG. 23 is a functional block diagram corresponding to FIG. 2 illustrating a configuration of functions of the reading device 100 which is a fifth embodiment of the character string reading device of the present invention.

FIG. 24A and FIG. 24B are flowcharts of a process corresponding to FIG. 4 executed by CPU 121 of the reading device 100 of the fifth embodiment.

### DESCRIPTION OF EMBODIMENTS

Embodiments of the present invention will be explained referring to the drawings.

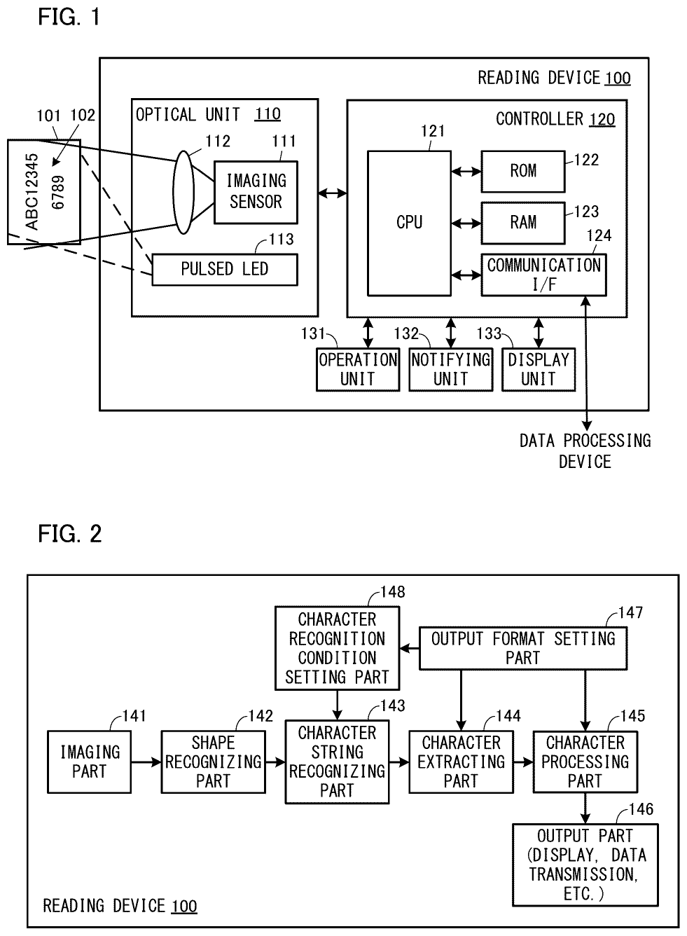

### First Embodiment: FIG. 1 to FIG. 9B

A first embodiment of the present invention will be described.

FIG. 1 is a block diagram illustrating a hardware configuration of a reading device 100 which is a first embodiment of the character string reading device of the present invention.

The reading device 100 illustrated in FIG. 1 is a device configured to optically read a character string 102 on a read object 101, having a light reflectance different from that of the surroundings, and is also an imaging device that captures an image of the read object 101 at the time of the reading. Further, the reading device 100 may have a function as an optical information reading device configured to optically read a one-dimensional or two-dimensional code symbol on the read object 101, represented by symbols having a light reflectance different from that of the surroundings.

The reading object 101 may be a recording medium that statically carries the character string 102 or the code symbol, or may be a display device that dynamically displays them.

As illustrated in FIG. 1, the reading device 100 includes an optical unit 110, a controller 120, an operation unit 131, a notifying unit 132, and a display unit 133.

Among these, the optical unit 110 is an imaging device that includes an imaging sensor 111, a lens 112, and a pulsed LED (light-emitting diode) 113, and is configured to optically capture an image of the read object 101 including the character string 102.

The imaging sensor 111 is an imaging part configured to capture an image of an imaging object such as the read object 101. The imaging sensor 111 can be constituted by, for example, a CMOS (complementary metal-oxide semiconductor) image sensor. Further, the imaging sensor 111 can generate image data indicating each pixel value based on charge accumulated in each pixel of the image sensor thorough the capturing, and output the image data to the controller 120. In this imaging sensor 111, pixels are two-dimensionally arranged.

The lens 112 is an optical system configured to form an image of the reflected light from the imaging object on the imaging sensor 111.

The pulsed LED 113 is an illuminator configured to irradiate illumination light to the imaging object of the imaging sensor 111.

Next, the controller 120 includes a CPU 121, a ROM 122 that stores data such as computer programs to be executed by the CPU 121 and various tables and the like, a RAM 123 used as a work area when the CPU 121 executes various processes, and a communication I/F 124 for communicating with external devices.

The CPU 121 controls operation of the entire reading device 100 including the optical unit 110, the operation unit 131, the notifying unit 132, and the display unit 133 by executing computer programs stored in ROM 122 using RAM 123 as a work area, and thereby realizes various functions including those described later with reference to FIG. 2. These functions may include processes such as identification, display, output to the outside, and storage of the character string 102 included in the image data of the image captured by the imaging sensor 111, detection and notification of a possibility of misreading, and the like.

The communication I/F 124 is an interface for communicating with various external devices, such as a data processing device that uses the result of identification of the character string 102.

The operation unit 131 is an operation part including a button, a trigger and the like for accepting operations by the operator. The notifying unit 132 is a hardware corresponding to a notifying part configured to perform various notifications to the operator. Conceivable concrete notification methods include, but not limited to, display of messages or data by a display device, lighting or blinking of a lamp, output of sounds by a speaker, and so on. The display unit 133 is a display part configured to display character strings identified by the reading device 100. The display unit can be constituted by a liquid crystal display device or the like. The notifying unit 132 and the display unit 133 may be common hardware.

When the reading device 100 is automatically operated under control from an external device or autonomous control, the operation unit 131, the notifying unit 132, and the display unit 133 need not be provided.

The reading device 100 described above can be configured as, for example, a hand-held or stationary character reading device or a code symbol reading device with a character reading function, but is not limited thereto. A general-purpose computer such as a smartphone or a personal computer may be used as all or a part of the hardware.

In the reading device 100 described above, one of the characteristic points is a method of recognizing a character string included in an image. Next, this point will be explained.

First, functions related to reading of the character string 102 included in the reading device 100 will be described.

FIG. 2 is a functional block diagram illustrating a configuration of the functions.

As illustrated in FIG. 2, the reading device 100 has functions of an imaging part 141, a shape recognizing part 142, a character string recognizing part 143, a character extracting part 144, a character processing part 145, an output part 146, an output format setting part 147, and a character recognition condition setting part 148. In the embodiment described here, the functions of the respective parts are realized by the CPU 121 controlling necessary units of the reading device 100 including the optical unit 110 through execution of a software, but some or all of the functions may be realized by dedicated control circuits.

The imaging part 141 illustrated in FIG. 2 has a function of an image obtaining part that controls the optical unit 110 to perform an imaging, obtains image data captured through the imaging, and transfers the obtained image data to the shape recognizing part 142. The imaging conditions may be determined in accordance with a known method as appropriate.

The shape recognizing part 142 has a function of recognizing shapes (figures) existing in the image represented by the image data transferred from the imaging part 141, and transferring information of the recognized shapes to the character string recognizing part 143. The recognition of the shapes can be performed, for example, by detecting positions of edges at which pixel values abruptly change in the image, and recognizing a region surrounded by the detected edges forming a closed loop as a shape. In addition, any known method, for example, binarizing the image and labeling portions where consecutive pixels having different values from the background exist, may be employed. When some shape is recognized, the position (existing region), the size, the typical pixel value, and the typical sharpness of the edge thereof are preferably calculated and stored. The typical pixel value of the background around the recognized shape is preferably also stored together.

The shape recognizing part 142 transfers data of each of the recognized shapes to the character string recognizing part 143.

The character string recognizing part 143 has a function of recognizing a character string existing in the image captured by the imaging part 141 based on the data of the shapes transferred from the shape recognizing part 142, and transferring the recognized character string to the character extracting part 144.

The recognition of the character string can be performed, for example, as follows.

First, extract a region in which shapes in similar sizes are arranged substantially linearly. When it is expected that characters are arranged in a specific direction, for example, in the horizontal direction, in the read object character string, only a region in which the shapes are arranged approximately in that direction may be extracted.

Then, recognize one shape or a combination of shapes existing in close proximity in the extracted region as a character candidate shape, and perform feature comparison to compare the character candidate shape and the characters registered in advance based on their features. According to the result of the feature comparison, recognize the character candidate shape as a character representing the highest matching rate among the registered characters.

Then, recognize the character string obtained by concatenating the characters recognized in the extracted region as a character string existing in the extracted region.

The only characters that can be recognized in this process are those used for the feature comparison. All the characters for which data is registered in the reading device 100 may be used in the feature comparison. However, in the reading device 100, which characters among the registered characters are used in the feature comparison can be set, as a character recognition condition. For example, when only digits are used in the feature comparison, even if the other characters exist in the image, only the digits can be identified as specific characters in the recognition. This is one of the features of this embodiment.

In addition, among the character candidate shapes, one having low matching rate with respect to features of any character used in the feature comparison can be recognized as an indefinite character which cannot be identified as any specific character. However, for example, character candidate shapes that have width or height different from those of characters recognized in the same region to some extent may be recognized as shapes not constituting any character.

The character recognition condition setting part 148 sets the above-described character recognition condition. Details thereof will be described later.

The character extracting part 144 has a function of a character string obtaining part that extracts a character string to be output from among the character string transferred from the character string recognizing part 143, and transfers the extracted character string to the character processing part 145.

The character processing part 145 has a function of processing as necessary the character string to be output, which is transferred from the character extracting part 144, and transferring the processed character string to the output part 146.

The output part 146 has a function of outputting data of the character string transferred from the character processing part 145 to an external device such as a data processing device and notifying the operator of the successful reading, using the communication I/F 124 and the notifying unit 132. The notification to the operator may be performed by any method such as a buzzer or vibration, or need not be performed when not required. Further, the output part 146 may have a function of displaying the character string transferred from the character processing part 145 on the display unit 133.

The extraction of the character string in the character extracting part 144 and the processing of the character string in the character processing part 145 are performed in accordance with an effective output format.

The output format setting part 147 functions as a format obtaining part, and selects and sets an output format to be effective, from among the output formats registered in advance, according to an operation by the operator or automatically.

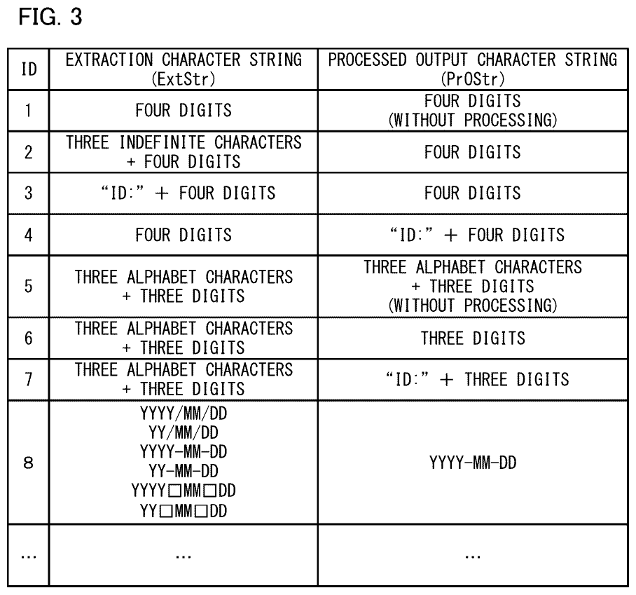

FIG. 3 shows examples of the output format.

As illustrated in FIG. 3, the output format includes: an extraction character string (hereinafter abbreviated to “ExtStr”) that indicates a character string to be extracted by the character extracting part 144; and a processed output character string (hereinafter abbreviated to “PrOStr”) that indicates a character string to be generated by processing the character string extracted according to the ExtStr and finally output from the output part 146. ID is identification data for identifying individual output formats.

The reading device 100 registers an arbitrary number of such output formats, and the output format setting part 147 can select one or a plurality of arbitrary output formats from among the registered output formats and set to use the one or the plurality of output formats as effective ones.

The ExtStr and the PrOStr can be defined by, for example, type and number of characters. Further, the PrOStr can be defined as a processing rule indicating how to process and output the character string extracted according to the ExtStr. For example, the processing rule can be defined by which part of the ExtStr is to be output.

For example, the output format of ID=1 defines to extract four digits as the character string to be output, in the ExtStr, and also defines to output the four digits without processing, in the PrOStr. The fact that the ExtStr and the PrOStr are the same indicates that processing in the character processing part 145 is not necessary.

As the character type, in addition to commonly used types such as digits, alphabet characters (English alphabet; upper case letters and lower case letters may be distinguished from each other), or symbol characters, the above-described “indefinite character” may be used.

For example, the output format of ID=2 defines to extract a character string in which three indefinite characters and four digits are consecutive as the character string to be output, in the ExtStr, and also defines to process the extracted character string to extract the portion of the four digits for output, in the PrOStr.

In addition, a character group constituted of arbitrary characters can be used as the character type. For example, a group of three alphabet characters “A”, “B”, and “C” may be defined as a character type X, and the ExtStr may indicate “three characters of type X” or the like. Further, as used in the output formats of ID=3 and ID=4, the output format may define a character string including some fixed character string such as “ID:”. The output format of ID=3 defines to extract a character string in which four digits follow “ID:”, in the ExtStr.

The PrOStr may indicate to add some characters to the extracted character string to output them. The output format of ID=4 defines to process the four digits extracted according to the ExtStr to add the character string of “ID:” therebefore for output, in the PrOStr.

In addition, a plurality of character strings may be defied in the ExtStr of one output format. Here it is assumed that such definition means a part that matches any one of the plurality of character strings should be extracted from the character string transferred from the character string recognizing part 143. Further, it may be allowed to define that digits, symbol characters and the like are arranged in a special combination, in the ExtStr. This can be used, for example, to create an output format defining a format of date.

In the ExtStr of the output format of ID=8, “YYYY” and “YY” respectively indicate numeric character strings of four digits and two digits indicating year in AD, “MM” indicates a numeric character string indicating month of the calendar in two digits or one digit, and “DD” indicates a numeric character string indicating day of the calendar in two digits or one digit. “/”, “-”, “□(space)” indicate delimiters that separate the year, the month, and the day. In this case, MM or DD cannot be just any numbers. For example, if a combination of MM=02, DD=31 that is inappropriate as a date is extracted, the combination is determined not to match the ExtStr.

Such a complicated output format can also be adopted depending on the algorithm utilized in the character extracting part 144 to extract a character string.

Note that the PrOStr of ID=8 indicates to process the extracted character string into a format of “YYYY-MM-DD” for output, regardless of according to which format of the ExtStr the character string was extracted.

Further, for use in setting a character recognition condition to be described later, information indicating which character may be extracted as a specific character according to the definition in the ExtStr may be included in the output format in association with the ExtStr.

For example, the characters that may be extracted are digits only in the output format of ID=1, whereas alphabet characters and digits in the output formats of ID=5 to 7.

Note that the indefinite character is not a specific character and it cannot be targeted for detection, so the indefinite character is not included in “characters that may be extracted”. Thus, even in the output format of ID=2, the characters that may be extracted are digits only.

When the ExtStr includes some fixed character string as in ID=3, the characters constituting the fixed character string are also “characters that may be extracted”. Thus, in the output format of ID=3, the characters that may be extracted are three characters “I”, “D”, and “:” in addition to digits.

Further, the characters that may be extracted according to the output format of ID=8 are three characters “/”, “-”, and “□(space)” in addition to digits. Here, only the characters to be extracted need to be considered as they are, and therefore “Y”, “M”, and “D” in the output format of ID=8 can be considered as mere digits.

Returning to FIG. 2, the character recognition condition setting part 148 has a function of setting a character recognition condition that defines which characters are to be identified by the character string recognition in the character string recognizing part 143 based on the effective output format set by the output format setting part 147. The character recognition condition setting part 148 sets the character recognition condition so that all characters that may be extracted according to the ExtStr of the effective output format can be identified (recognized).

For example, if the characters that may be extracted are digits only, the character recognition condition is set so that at least all the digits can be identified. For this purpose, for example, setting may be made such that at least all of the digits should be compared with the character candidate shapes in the character string recognition. When such a setting is made, all digits included in the image can be identified in the character string recognition, but characters other than the digits cannot be identified as specific characters (which could be recognized as indefinite characters). On the other hand, even if only digits can be identified, there is no problem in extracting a character string to be output in the character extracting part 144.

It should be noted that even if characters other than digits are compared with the character candidate shapes in addition to digits, basically it is considered possible to identify the digits, and such setting is not precluded. Even if such setting is made, basically there is no problem in extracting the character string to be output, in the character extracting part 144.

That is, it is sufficient to set, as the character recognition condition, that only a group of (specific) characters including all characters defined by (the ExtStr of) the effective output format are to be identified among the characters for which the reading device 100 has data to be compared with the character candidate shapes (that is, characters which the reading device 100 can identify).

The group of characters to be compared with the character candidate shapes can be defined by commonly used character types such as digits or alphabet characters, and can also be defined by specification of arbitrary individual characters. Individual characters such as “I”, “D”, and “:” may be added or excluded. The group can also be defined using ranges, such as A to C only in alphabet characters.

In addition, when a plurality of effective output formats are set, the above-described group of characters is defined to include all the characters that may be extracted according to at least one of the effective output formats.

For example, if output formats of ID=3 and ID=5 are effective, the group of characters is defined to include all alphabet characters, digits and “:”. This is a sum set of: “I”, “D”, “:”, and digits that may be extracted according to the output format of ID=3; and alphabet characters and digits that may be extracted according to the output format of ID=5.

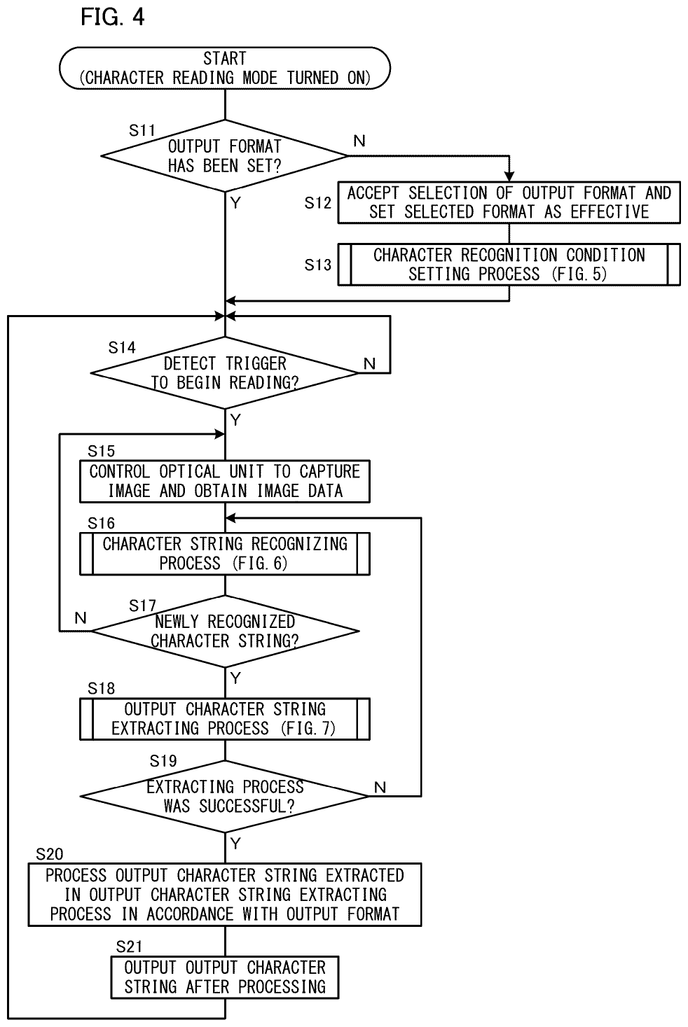

Next, processes for realizing the functions described above will be described with reference to FIG. 4 to FIG. 7. The processes described here are ones according to a first embodiment of the character string reading method of the present invention.

FIG. 4 shows a flowchart of a process executed by the CPU 121 when a character reading mode is turned on in the reading device 100.

In this process, the CPU 121 first decides whether or not an effective output format has been set (S11). If some effective output format has been set in a previous process of FIG. 4, this decision results in Yes. On the other hand, if no effective output formats have been set, the CPU 121 accepts selection of an output format, obtains the selected output format, and sets it as an effective output format (S12). It is conceivable to allow to set a newly created output format in addition to the output format prepared in advance.

The process of step S12 described above is a process of an output format obtaining step, and corresponds to the function of the output format setting part 147.

Thereafter, the CPU 121 executes a character recognition condition setting process to set a character recognition condition according to the effective output format (S13).

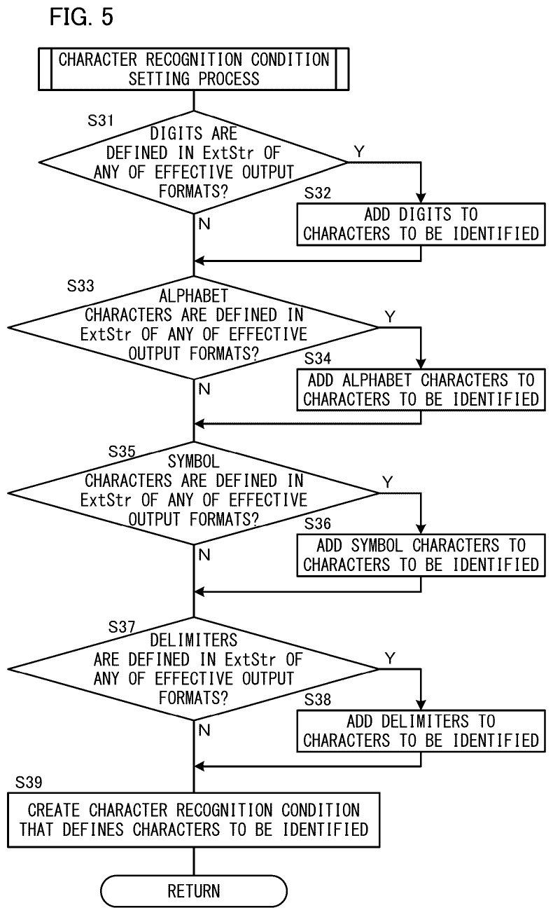

This character recognition condition setting process is illustrated in FIG. 5, for example.

In the process of FIG. 5, first, if digits are defined in the ExtStr of any of the effective output formats (Yes in S31), the CPU 121 adds digits to characters to be identified, that is, characters to be compared with character candidate shapes in the character string recognition (S32). It is assumed that no characters are defined as characters to be identified, at the start of the process of FIG. 5.

In the same way, regarding each type of alphabet characters, symbol characters, and delimiters, if that type of characters is defined in the ExtStr of any of the effective output formats, the CPU 121 adds the type of characters to characters to be identified (S33 to S38). Here, the delimiters are assumed to be three characters of “/”, “-”, and a space, but not limited thereto. Further, as described above, it is conceivable to allow to add or exclude characters to/from the characters to be identified not only by types of characters but also for each character.

Next, the CPU 121 creates a character recognition condition that defines the characters to be identified, which have been determined in the process up to step S38, and enables the condition (S39). Then, the CPU 121 returns to the original process.

The process of FIG. 5 described above is a process of a character recognition condition setting step, and corresponds to the function of the character recognition condition setting part 148.

Returning to FIG. 4, after step S13 or if Yes in step S11, the CPU 121 waits until a trigger to begin reading is detected (S14). As the trigger, for example, an operation on the operation unit 131 by an operator or a signal transmitted from an external device connected to the communication I/F 124 can be adopted.

When the trigger is detected, the CPU 121 controls the optical unit 110 to capture an image and obtain image data (S15). The process of step S15 is a process of an image obtaining step, and corresponds to the function of the imaging part 141.

Next, the CPU 121 performs a character string recognizing process on the image data obtained in step S15 (S16).

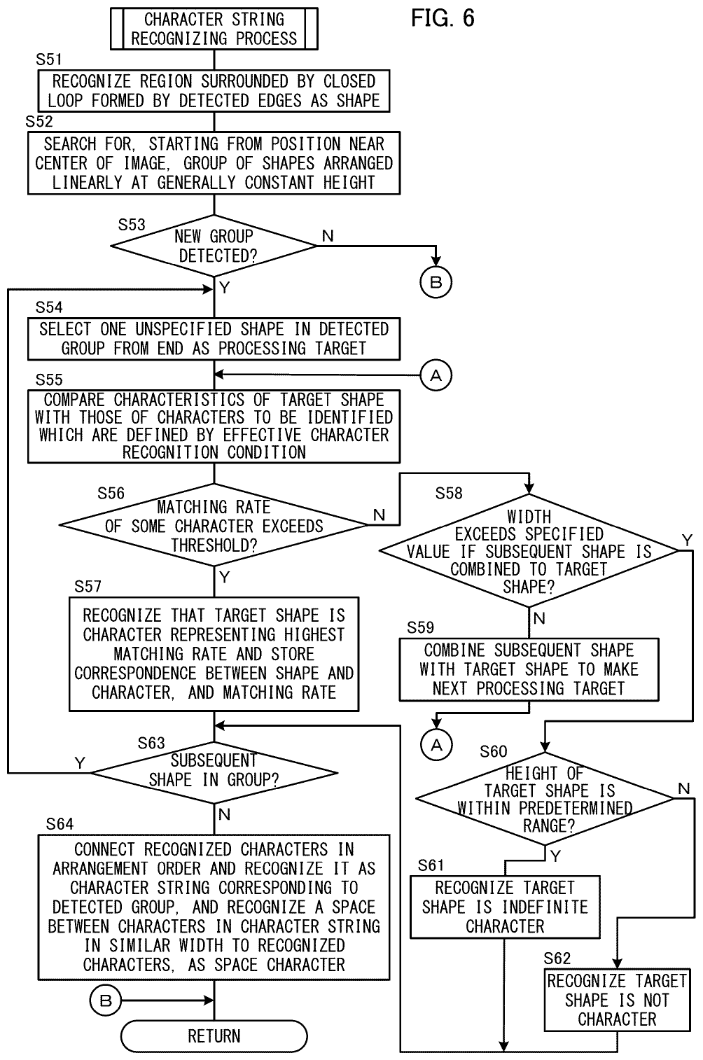

This character string recognizing process is illustrated in FIG. 6, for example.

In the process of FIG. 6, the CPU 121 first detects edges in the image at which pixel values abruptly change, and recognizes a region surrounded by a closed loop formed by the detected edges as a shape (S51). Shapes recognized herein include those that constitute a character and those that do not. The process of step S51 is a process of a shape recognizing step, and corresponds to the function of the shape recognizing part 142.

The CPU 121 then searches for, starting from a position near the center of the image, a group of the shapes that are arranged linearly at a generally constant height (S52). Since a character string to be read is assumed to be constituted of characters having a substantially constant height arranged in a straight line, the shapes constituting such a group is considered to be candidates of shapes constituting the arranged characters.

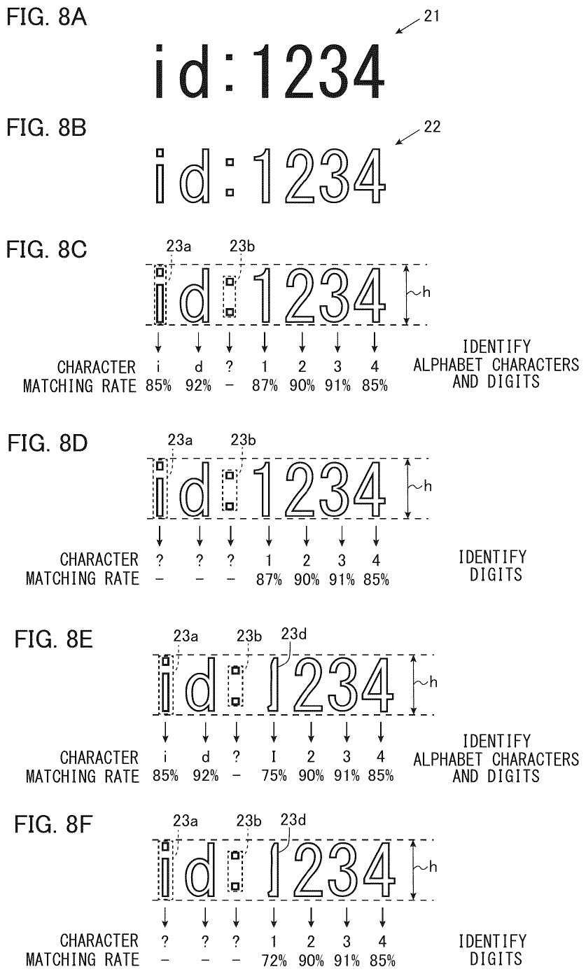

Here, the height is a direction orthogonal to the arrangement direction of the shapes. Further, for example, when one character is constituted by a plurality of shapes, like “i” and “:” shown in FIG. 8B, there is a possibility that small-size shapes also constitute a character. Thus, the heights of the individual shapes need not approximate the height of the region in which the group of the shapes are arranged linearly, nor need all of the shapes in the group be aligned in one straight line.

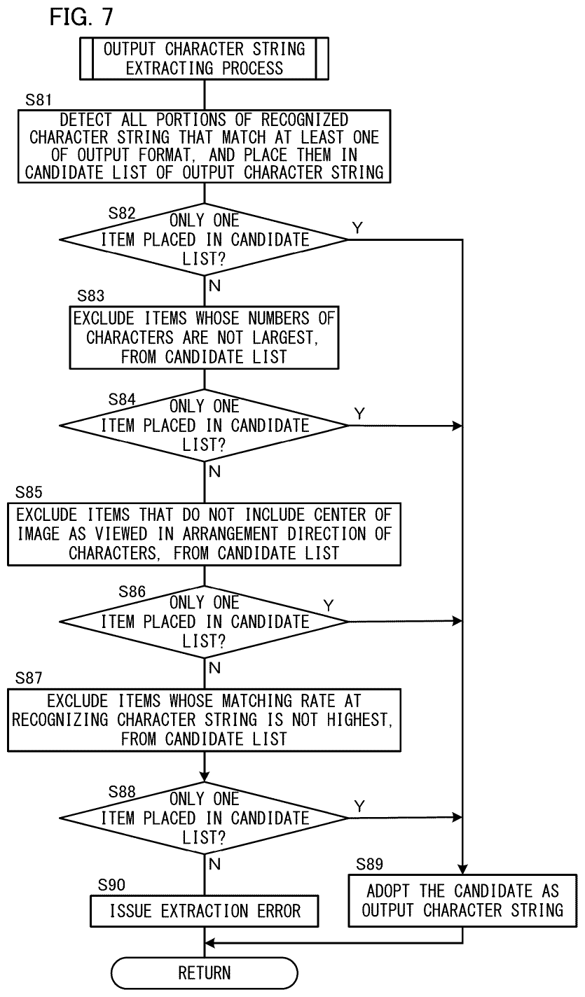

The reason why the search is started from the position near the center is that the operator of the reading device 100 normally moves the reading device 100 or the read object 101 when executing the reading so that the character string to be read is located in the center of the imaging area. By searching in order from the position near the center, it is possible to increase the possibility that a character string which the operator wants to read is detected first and proceeds to the output character string extracting process of FIG. 7 as described later. However, it is not essential to start the search from a position near the center. Conversely, the shape recognition in step S51 may also be performed in order starting from the position near the center of the image in conjunction with the group search.

Anyway, when the CPU 121 detects a new group in the search in step S52 (Yes in S53), the CPU 121 proceeds to step S54 and the subsequent steps.

Then, the CPU 121 first selects one unspecified shape in the detected group from the end to be a processing target (S54). The selection may be made as with the order in which the letters are written. If writing from left to right is assumed, the selection may also be made from the left end.

Next, the CPU 121 compares characteristics of the target shape with those of the characters to be identified which are defined by the effective character recognition condition (S55). This comparison may be performed between the images, or between the features calculated from the images, or both.

Then, when there is one or more characters whose matching rate exceeds a threshold determined as a sufficient value for identifying the character (Yes in S56), the CPU 121 recognizes that the target shape is the character representing the highest matching rate among the one or more characters, and stores the correspondence between the target shape and the character, and the matching rate (S57).

On the other hand, if No in step S56, the target shape cannot be recognized (identified) as any character. In this case, the CPU 121 decides whether or not the width of the entire target shape exceeds a specified value if the subsequent shape in the group is combined with the present target shape (S58). The specified value can be obtained, for example, by multiplying the height of the region in which the group of the shapes are arranged linearly, by an upper limit of the aspect ratio of standard characters.

If No in step S58, even if the present target shape is combined with the subsequent shape, the combined shape will still be a character candidate. Then, the CPU 121 combines them to make a next processing target (S59), and returns to step S55 to repeat the process.

If Yes in step S58, it is considered that if the present target shape is combined with the subsequent shape, it will no longer be any character. Accordingly, to determine handling of the target shape without the combining, the CPU 121 decides whether or not the height of the target shape is within a predetermined range (S60). This predetermined range can be obtained, for example, by multiplying the height of the region in which the group of the shapes are arranged linearly, by a value that can be taken by a standard character as a ratio of the height of the character to the height of the region. In addition, the position of the target shape in the height direction in the region may be taken into consideration. This is because there may be a character having an extremely small height, such as “.”

If Yes in step S60, the CPU 121 decides that the target shape is a certain character even if it is not possible to identify which character it is, and recognizes that the target shape is an indefinite character (S61). Since the characters to be identified are narrowed down by the character recognition condition, it is naturally assumed that the captured image includes characters that cannot be identified. Further, characters that are not registered in the reading device 100 cannot be identified originally.

On the other hand, if No in step S60, the CPU 121 decides that the target shape is not a character, and recognizes it so (S62).

The process related to the target shape is completed at any of steps S57, S61, and S62. Then, the CPU 121 proceeds to step S63, and as long as there is a subsequent shape in the group (Yes in S63), returns to step S54 to repeat the process.

When No in step S63, the CPU 121 connects the characters recognized so far in the arrangement order to obtain a character string, and recognizes the character string as that corresponding to the group detected in step S53. At this time, if there is a space between the characters in the character string in similar width to the recognized characters, the space is recognized as a space character (S64). A space of about n times the width of the character may be recognized as n space characters, where n is a natural number.

After step S64, that is, when one character string is recognized in the image, the CPU 121 temporarily ends the character string recognizing process, and returns to the original process.

If no new group is detected in the search of step S52, the decision in step S53 results in No. The negative decision may be made if no new groups are detected within a predetermined time, a predetermined number of trials, or the like. In this case as well, the CPU 121 ends the character string recognizing process, and returns to the original process.

The process of steps S52 to S64 is a process of a character string recognizing step, and corresponds to the function of the character string recognizing part 143. This process includes processes of a character candidate specifying step and a character identifying step.

Returning to FIG. 4, after step S16, if some character string was newly recognized in step S16 (Yes in S17), the CPU 121 performs an output character string extracting process on the recognized character string as a processing target (S18).

This output character string extracting process is illustrated in FIG. 7, for example.

In the process of FIG. 7, the CPU 121 first detects, for each effective output format set in step S12, all portions of the target character string (first character string) newly recognized in step S16 that match at least one of the definition(s) in the ExtStr of the output format, and places the detected portions in a candidate list of output character string (second character string) (S81). At this time, if there is no portion in the target character string that matches the definition in the ExtStr of any output format, no candidate is detected. Conversely, multiple portions may be detected as the candidates. In addition, the CPU 121 registers in the candidate list information on which output format has been matched, in association with the character strings of the portions matching the definition, and output the information in step S89.

If only one item is placed in the candidate list in step S81 (Yes in S82), the CPU 121 adopts the one candidate as the output character string (S89), ends the output character string extracting process, and returns to the original process. Although not necessary, it is preferable from the viewpoint of preventing misreading to set the output format so that the decision in S82 results in Yes when the intended reading is performed.

On the other hand, if No in step S82, the CPU 121 excludes items whose numbers of characters are not the largest from the candidate list (S83). Conversely, only items with the largest number of characters are left in the candidate list. Then, if only one item remains in the candidate list (Yes in S84), the CPU 121 adopts the one candidate as the output character string (S89), and returns to the original process.

By the process of steps S83 and S84, even if there is a portion matching the output format in the first character string as for each of plural output formats, the portion that matches the output format over the longest number of characters can be extracted as the output character string.

It is considered that the output format matching the first character string in a longer range is less likely to be incorrectly matched due to misreading than another output format matching in a shorter range, and there will be fewer portions to be the candidates according to such output format. Accordingly, it is considered that, by preferentially adopting a candidate matching the output format in a longer range, a portion which the operator actually intends to read can be appropriately extracted as the output character string.

On the other hand, the decision in S84 results in No when there are plural items with the same number of characters, and these items cannot be distinguished by the number of characters. Typically, such case occurs when there are plural portions in the first character string that match the output format with the longest ExtStr.

When No in step S84, the CPU 121 excludes, from the candidate list, items that do not include the center of the image as viewed in the direction of the arrangement of characters in the character string. Conversely, only items including the center of the image are left in the candidate list. Then, if only one item remains in the candidate list (Yes in S86), the CPU 121 adopts the one candidate as the output character string (S89), ends the output character string extracting process, and returns to the original process. Thus, when there are plural portions matching the output format in the first character string, a portion close to the center of the image can be extracted as the output character string.

In step S85, for example, when the characters are arranged in the horizontal direction, if the character string includes the center of the image when viewed in the horizontal direction, it is decided that the character string “includes the center” even if the character string does not include the center of the image in the vertical direction.

When the operator captures an image of the character string 102 to be read, it is assumed that the image is captured so that a portion to be actually read comes to the center of the imaging area. Therefore, it is considered that by preferentially adopting a candidate at a portion close to the center of the image, a portion which the operator actually intends to read can be appropriately extracted as the output character string, rather than an unintended matching portion caused by a parting or the like. Since the character string close to the center in the entire image has already been prioritized in step S52 in FIG. 6, it is sufficient to consider only the position in the arrangement direction of the characters in step S85.

On the other hand, the decision in S86 results in No when there are plural items including the center of the image, and these items cannot be distinguished by either of the number of characters and whether or not they are at the center. Typically, such case occurs when, for example, the ExtStr is four digits and the recognized character string includes a portion in which five digits are consecutive, such as “12345”, plural portions which are slightly (one character in this example) deviated from each other, such as “1234” and “2345”, are detected, and all of the detected portions include the center of the image. Even in this case, it is possible to numerically distinguish which portion is closer to the center, but such subtle difference does not necessarily reflect the intention of the operator. Therefore, the process of FIG. 7 attempts to distinguish candidates by a criterion other than position, if the candidates cannot be distinguished by the criterion of “including the center”.

When No in step S86, the CPU 121 excludes items whose matching rate at the time of recognizing the character string is not the highest from the candidate list (S87). Conversely, only the item having the largest matching rate is left in the candidate list. Then, if only one item remains in the candidate list (Yes in S88), the CPU 121 adopts the one candidate as the output character string (S89), and returns to the original process. Thus, when there are plural portions matching the output format in the first character string, the portion having the highest matching rate can be extracted as the output character string.

When a plurality of characters are included in the item, the matching rate of the entire item may be determined by an appropriate method, such as an average value or a maximum value, based on the respective values related to the respective characters. In addition, when the matching rates of the respective items are compared with one another, values in a predetermined error range may be regarded to be equal, or the values may be classified and items having matching rates in the same class may be regarded to have the same matching rate.

In general, since it is considered that the matching rate is low at a portion where misreading has occurred, it is considered that, by preferentially adopting a candidate having a higher matching rate as described above, a portion where characters are correctly identified can be extracted as the output character string even in a case where plural portions unexpectedly match the output format due to misreading.

The decision in S88 also becomes No when there are plural items that cannot be distinguished by any of the number of characters, the position in the image, and the matching rate. In this case, the CPU 121 determines that it is not possible to uniquely identify a valid output character string. Then, the CPU 121 issues an extraction error (S90), and returns to the original process.

Note that even when no portion is detected as the candidates in step S81, the decisions in steps S82, S84, S86 and S88 are all No. In this case as well, the CPU 121 may issue the extraction error in step S90 and return to the original process. The extraction error in this case may be an error different from that in the case where a plurality of items (candidates) could not be distinguished from one another.

The process of FIG. 7 is a process of a character string obtaining step, and corresponds to the function of the character extracting part 144.

Returning to FIG. 4, after step S18, the CPU 121 decides whether or not the extraction in the output character string extracting process was successful (S19). This decision results in No when the extraction error has been issued, and Yes if some outputting character string could have been adopted.

If No in step S19, the CPU 121 returns to step S16, and perform the character string recognizing process again. At this time, the results of the shape recognition in step S51 and the history of the search in step S52 thus far are utilized as appropriate. When a character string is newly recognized in this process, the decision in step S17 results in Yes, and therefore the CPU 121 executes the output character string extracting process in step S18 again on the newly recognized character string as a processing target.

On the other hand, if No in step S17, the CPU 121 returns to step S15 and retry the imaging. If the predetermined number of retries has been exceeded, the CPU 121 may issue a read error and return to step S14.

If Yes in step S19, the CPU 121 processes the output character string adopted in the process of FIG. 7 as needed in accordance with the indication of the PrOStr of the corresponding output format (S20). This process is a process of a processing step and corresponds to the function of the character processing part 145.

Then, the CPU 121 outputs data of the output character string after the processing (S21), and here the process related to one reading is completed. Then the CPU 121 returns to step S14, and repeats the process. The process of step S21 is a process of an output step, and corresponds to the function of the output part 146.

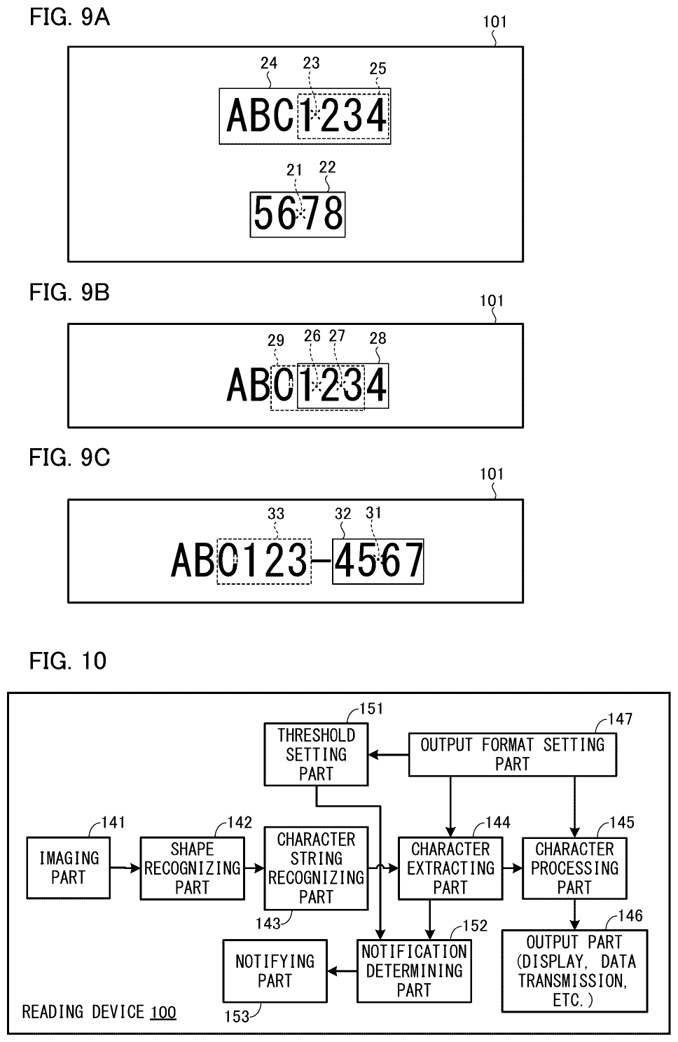

Next, advantageous effects of the first embodiment will be described with reference to FIG. 8A to FIG. 9C.

First, as an example, a case where four digits (in the example of FIG. 8A, “1234”) are read from a reading object on which the four digits following the letters “id:” are printed as a character string 21 as shown in FIG. 8A.

In this case, when the shape recognition is performed as in step S51 of FIG. 6 on the image obtained by capturing the character string 21 and shapes are correctly recognized, a group 22 of shapes composed of the outlines of the respective characters is detected as shown in FIG. 8B. As shown in FIG. 8C, the group 22 is composed of the shapes that are arranged linearly in a region of approximately height h. Such group 22 of the shapes can be detected through the search in step S52.

Then, by performing character string recognition on the group 22 of the shapes through the process of steps S54 to S64 in FIG. 6, the characters constituting the character string 21 and a character string constituted by the characters can be recognized. However, the character string actually recognized differs depending on the character recognition condition used here.

FIG. 8C shows an example of the recognition in which a character recognition condition that defines to identify alphanumeric characters and digits is used.

In the character recognition process, two shapes (a point and a bar) constituting the left-most “i” are combined with each other in step S59 to form one character candidate shape (processing target in step S55) 23a, and two shapes (two points) constituting “:” are similarly combined to form one character candidate shape 23b. Regarding each of “d” and “4”, the shape surrounded by the outer contour is different from the shape surrounded by the inner contour, but here the shapes are collectively recognized as one character candidate shape.

Alternatively, when there is a shape included in the inside of another shape (contour), the outer shape may be firstly handled as the processing target to be compared with the characteristics of the characters in step S55 of FIG. 6. If there is a character whose matching rate is above the threshold (and the largest), it is conceivable to determine that both the outer shape and the inner shape are the shapes constituting the character at that time. It is also conceivable to compare a combination of the outer shape and the inner shape with the characteristics of the characters again, and update the matching rate (and correspondence with characters) based on the result.

In any case, since alphabet characters and digits are expected to represent matching rates above the threshold in step S56 of FIG. 6, the characters “i”, “d”, “1”, “2”, “3”, and “4” are correctly identified. FIG. 8C also shows exemplary matching rates at the identification. On the other hand, since “:” is not included in the characters to be compared in step S55, the decision in step S56 results in No, and is finally recognized as an indefinite character in step S61. The indefinite character is indicated by “?”. Accordingly, the character string 21 is recognized as a character string of “id?1234”.

On the other hand, FIG. 8D shows another example of the recognition in which a character recognition condition that defines to identify digits is used. Here, the characters “1”, “2”, “3”, and “4” are correctly identified, but since “i” and “d” in addition to “:” are not included in the characters to be compared in step S55, those characters are recognized as indefinite characters. Therefore, the character string 21 is recognized as a character string of “???1234”.

Here, since the character string to be read is four digits, the output format of ID=1 shown in FIG. 3 can be used.

Then, in both cases of FIG. 8C and FIG. 8D, since only one portion of “1234” among the recognized character string matches the ExtStr of the output format, it is possible to extract this portion as an output character string and output it. Of course, the same applies to the case where symbol characters are also identified.

However, since it can be seen from the effective output format that the characters actually intended to read are digits only, the processing load in the character recognition process, especially step S55, can be reduced by setting the character recognition condition that defines to identify digits only, resulting in the character recognition process with lower overhead.

In addition, depending on the imaging conditions, an image slightly different from the actual character string 21 may be captured due to blur, overexposure, reflection of a shadow, or the like at the time of imaging, and the result of the shape recognition may also be slightly different from the actual characters.

FIG. 8E and FIG. 8F respectively show exemplary cases where the letter “1” is recognized as a shape slightly different from the actual shape, as indicated by the reference sign 23d. It is assumed that this shape is closer to (having larger matching rate with) the letter “I” of the alphabet rather than “1”.

In this case, if the character recognition condition that defines to identify alphabet characters and digits is used, the character “1” will be identified as “I” as shown in FIG. 8E. Then, the character string 21 is recognized as “id?1234”, and there is no portion that matches the ExtStr of the output format.

On the other hand, when the character recognition condition that defines to identify digits only is used, since the comparison with “I” is not performed, the matching rate with “1” will be the maximum. If the matching rate exceeds the threshold in step S56, the shape 23d is correctly identified as “1” as shown in FIG. 8F. Accordingly, as in the cases shown by FIG. 8C and FIG. 8D, “1234” can be extracted and output.

In this way, by setting the character recognition condition and performing the comparison with the shapes focusing only on the characters that need to be identified as specific characters in accordance with the output format, even when the imaging condition is not ideal, the characters to be output can be correctly recognized and the substantive accuracy of the character recognition can be improved.

Note that it is conceivable that possibility of misidentification of “i” as “1” will be slightly increased by focusing only on digits in the comparison, for example, in contrast to the case of FIG. 8E. However, in the examples shown in FIG. 8A to FIG. 8F, even if the character string “1d?1234” is recognized due to this misidentification, the output character string will not be affected.

Even in the case where such misidentification is likely to cause a problem, by additionally adopting the function of notifying possibility of misreading which will be described in the second to fourth embodiments later, it is possible to obtain the effect of improving accuracy and reducing processing load while suppressing convenience deterioration due to the misidentification.

In addition, if it is desired to read four digits in the character string 21 in distinction from another portion where four digits are solely printed, the output format of ID=2 shown in FIG. 3 may be adopted. In this case, when the character string 21 is recognized as “???1234” as shown in FIG. 8D or FIG. 8F, the entire character string matches the ExtStr, and extracted as the output character string. Then, the output character string can be processed into a character string of only the portion of four digits, that is “1234”, in accordance with the PrOStr.

Even when a character string of only “1234” is read, since there are no indefinite characters, the read character string does not match the ExtStr, and thus not extracted as an output character string.

In this way, even when alphabet characters or symbol characters are not identified as a specific character, it is possible to perform extraction on the assumption that some alphabet characters or symbol characters exist, by recognizing them as indefinite characters.

Note that the characters “i” and “:” are likely to be misidentified, and may not be correctly recognized as “indefinite character”. In consideration of this, it is also conceivable to describe the ExtStr as “any one character +one to two indefinite characters +four digits”. “Any one letter” means that it may be any of an indefinite character and some specific character (for example, “1”). “One to two indefinite characters” is described in consideration of the case where “:” is not recognized and the character string 21 is recognized as “1?1234”.

Next, another case where the operator intends to read both of character strings listed in two lines as shown in FIG. 9A will be discussed. The upper line contains three alphabet characters and four digits, and the lower line contains four digits only. In this case, by setting an output format (format A1) having an ExtStr indicating “three alphabet characters +four digits”, and another output format (format A2) having an ExtStr indicating “four digits”, sequentially targeting the character strings in the upper line and the lower line and providing a reading start trigger for each, the upper and lower character strings can be read respectively.

For example, when the operator intends to read the lower character string, it is generally considered that the reading is performed in a state where the position of the reference sign 21 comes to the vicinity of the center of the imaging area. Then, a group of shapes corresponding to the lower character string is first extracted in step S52 of FIG. 6, and the process of FIG. 7 is performed regarding the character string “5678”, recognized in step S54 and the subsequent steps, as the first processing target. Then, even if both of the formats A1 and A2 are effective and the recognized character string is compared with both of them in step S81, the character string placed in the candidate list of the output character string is only one of “5678” indicated by the reference sign 22, and this character string is adopted as the output character string.

On the other hand, when the operator intends to read the upper character string, it is generally considered that the reading is performed in a state where the position of the reference sign 23 comes to the vicinity of the center of the imaging area. Then, a group of shapes corresponding to the upper character string is first extracted in step S52 of FIG. 6, and the process of FIG. 7 is performed regarding the character string “ABC1234”, recognized in step S54 and the subsequent steps, as the first processing target. In this case, two character strings, that is, “ABC1234” indicated by the reference sign 24 and corresponding to the format A1, and “1234” indicated by the reference sign 25 and corresponding to the format A2, are placed in the candidate list of the output character string. However, since “1234” is excluded in step S83 and only one candidate “ABC1234” remains then, and thus it is adopted as the output character string.

As described above, by performing the process of step S82 in FIG. 7, even if there is a character string that match plural output formats, the reading can be properly performed in accordance with the operator's intent.

Next, still another case where the operator intends to read only a part of a character string written in one line as shown in FIG. 9B will be discussed. This character string consists of three alphabet characters and four digits, among which four digits are to be read. In this case, an output format (format B) having an ExtStr defining “four digits” can be used.

Further, it is generally considered that the reading is performed in a state where the center of the entire character string indicated by the reference sign 26 or the center of the portion to be read indicated by the reference sign 27 comes to the vicinity of the center of the imaging area.

Then, a group of shapes corresponding to the entire character string is extracted in step S52 of FIG. 6. Assuming that the characters are correctly identified in step S54 and the subsequent steps, the process of FIG. 7 is performed regarding the character string “ABC1234” as a processing target. Then, since the character string that matches the format B and placed in the candidate list of the output character string is only one of “1234” indicated by the reference sign 28, this character string is adopted as the output character string.

On the other hand, for example, it is assumed that the image is captured so that the opening of “C” appears connected as indicated by a broken line in FIG. 9B, and the character of “C” is misidentified as “0” in the character string recognizing process of FIG. 6. In this case, the character string of “AB01234” is the target of the process of FIG. 7, and thus “0123” indicated by the reference sign 29 is also placed in the candidate list of the outputted character string in addition to “1234” indicated by the reference sign 28.

Both candidates remain in the list in step S83 because they have the same number of characters, and both remains also in step S85 because the character string includes the center of the image regardless of whether the center of the image is at the position of the reference sign 26 or 27. However, “0” in “0123” is considered to have a lower matching rate due to the misidentification. Accordingly, “0123” will be excluded in step S87, and only “1234” indicated by the reference sing 28 remains in the candidate list, and is adopted as the output character string.

As described above, by performing the process of step S87 in FIG. 7, even when there is a portion that unintentionally matches the output format due to misreading or misidentification, it is possible to reduce the possibility that the portion is adopted as the output character string, and thus it is expected that the readings will match the operator's intent at a higher frequency.

Next, still another example where the operator intends to read only a part of a character string written in one line as shown in FIG. 9C will be discussed. This character string consists of three alphabet characters, three digits, a hyphen, and four digits in this order, among which the last four digits are to be read. In this case, an output format (format B) having an ExtStr indicating “four digits” can be used.

In this case, since the entire character string is quite long in comparison with the portion to be read, it is generally considered that the reading is performed in a state where the center of the portion to be read indicated by the reference sign 31 comes to the vicinity of the center of the imaging area.

Even in this case, a group of shapes corresponding to the entire character string is extracted in step S52 of FIG. 6, and the process of FIG. 7 is performed regarding the entire character string as a processing target. Assuming that the characters are correctly identified, since the character string that matches the format B and placed in the candidate list of the output character string is only one of “4567” indicated by the reference sign 32, this character string is adopted as the output character string.

On the other hand, if the character “C” is misidentified as “0” as in the case of FIG. 9B, in addition to “4567” indicated by the reference sign 32, “0123” indicated by the reference sign 33 will be also placed in the candidate list of the output character string.

Although both candidates remain in the list in step S83 because they have the same number of characters, but “0123” is excluded in step S85 because it does not include the center of the image in the character string, and only “4567” indicated by the reference sign 32 remains in the list, and is adopted as the output character string.

As described above, also by performing the process of step S85 in FIG. 7, it is possible to reduce the possibility that the portion that unintentionally matches the output format due to misreading or misidentification is adopted as the output character string, and thus it is expected that the readings will match the operator's intent at a higher frequency.

In this embodiment, when the output character string is adopted in the process of FIG. 7, three elements of: the number of characters; the matching rate; and the position in the image, are taken into consideration. However, even if only some the three are considered, the effect thereof can be achieved. The order in which each element is considered is preferably the order shown in FIG. 7, but may be in a different order.

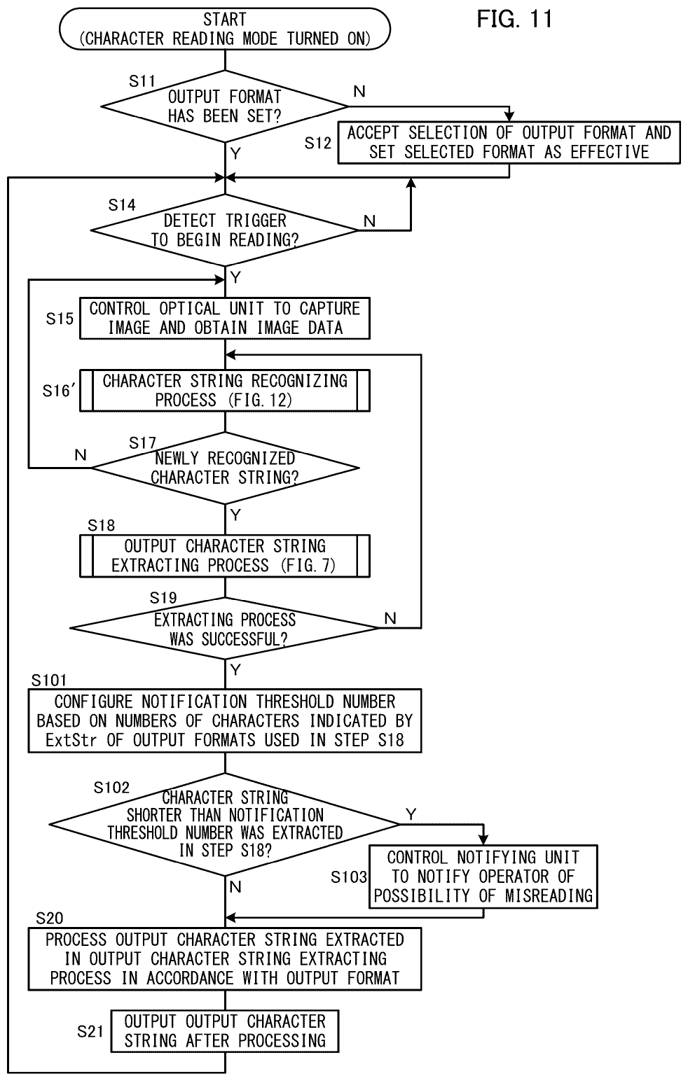

### Second Embodiment: FIG. 10 to FIG. 14B

Next, a second embodiment of the present invention will be described.

The reading device 100 of the second embodiment is different from that of the first embodiment in that the reading device 100 does not use the character recognition condition and notifies a possibility of misreading when the number of characters, which may be the number of digits, in the character string extracted in the output character string extracting process is less than a notification threshold number. Since the other portions are the same as those in the first embodiment, the matters related to the differences will be described, and the description of the common portions will be appropriately omitted. In addition, in the description of the second embodiment, the same reference signs as those of the first embodiment are used for portions common to or corresponding to the configurations of the first embodiment. The same applies to the third and subsequent embodiments.

First, functions related to reading of the character string 102 included in the reading device 100 of the second embodiment will be described.

FIG. 10 is a functional block diagram corresponding to FIG. 2, illustrating a configuration of the functions.

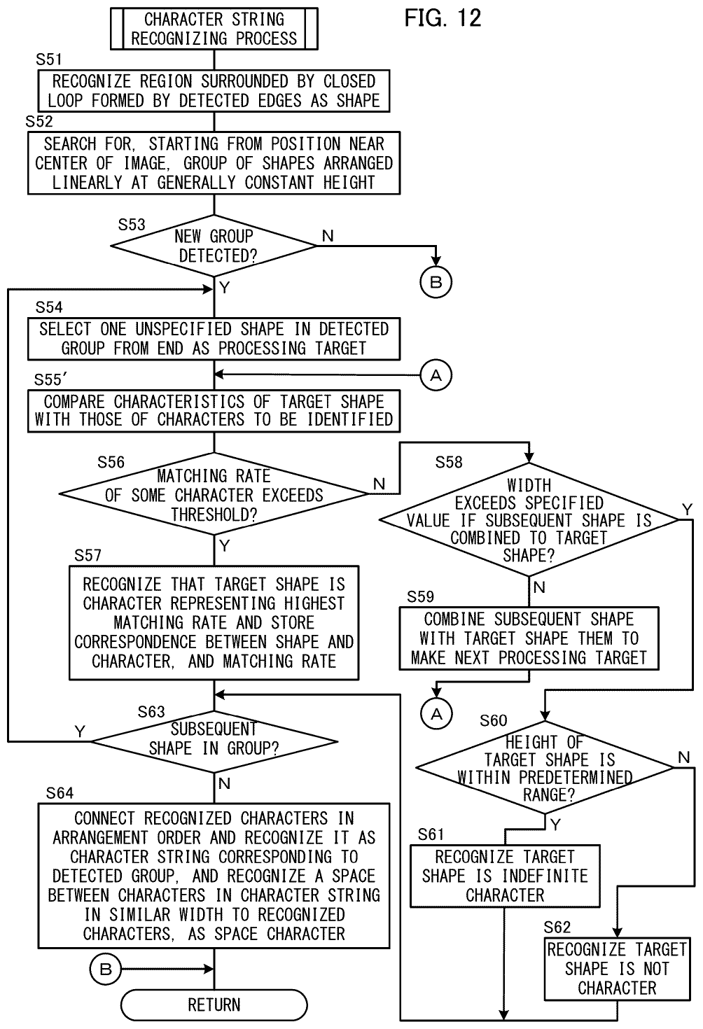

As illustrated in FIG. 10, the reading device 100 of the second embodiment includes a threshold setting part 151, a notification determining part 152, and a notifying part 153 in place of the character recognition condition setting part 148 of FIG. 2. Further, the character string recognizing part 143 performs character string recognition without using the character recognition condition, and this point will be described later with reference to FIG. 12.

The threshold setting part 151 has a function of determining and configuring the notification threshold number to be used as a criterion for whether or not to perform notification of a possibility of misreading, based on the effective output format.

The notification determining part 152 has a function of obtaining the number of characters of the output character string extracted by the character extracting part 144, and instructing the notifying part 153 to notify of the possibility of misreading when the obtained number of characters is less than the effective notification threshold number.

The notifying part 153 has a function of controlling the notifying unit 132 based on the instruction by the notification determining part 152 to notify the operator of the reading device 100 that there is a possibility that some misreading of a character string has occurred in the present reading, by an arbitrary means such as light, sound, display of a message or a mark. The misreading may be caused by misidentification of some character as described also in the first embodiment. This notification may be preferably performed in synchronization with the notification of output of the character string by the output part 146, or a notification of successful reading.

Next, processes for realizing the functions described above will be described with reference to FIG. 11 and FIG. 12. The processes described here are ones according to a second embodiment of the character string reading method of the present invention.

FIG. 11 shows a flowchart of a process corresponding to FIG. 4 executed by the CPU 121 when the character reading mode is turned on in the reading device 100.

The process of FIG. 11 differs from that of FIG. 4 only in that there is no step S13 after step S12, that step S16′ is executed instead of step S16, and that steps S101 to S103 are executed prior to step S20 when Yes in step S19.

Firstly, the point where there is no step S13 corresponds to the fact that the character recognition condition is not used.

The character string recognizing process in step S16′ is shown in FIG. 12. This process is almost the same as the process of FIG. 6, and only differs in that step S55′ is executed instead of step S55. The only difference between the two is that the character recognition condition is not considered in step S55′. In step S55′, the CPU 121 compares characteristics of the target shape with those of the characters to be identified.

The characters to be identified are, for example, all the characters for which the reading device 100 has data. However, it is not necessary to always compare the target shape with all the characters, and it is not precluded to limit the characters to be identified to only a partial list according to the operator's settings. Since the character recognition condition is not considered, there is simply no need to dynamically define the characters to be identified according to the effective output format.

Further, in the process of FIG. 11, if Yes in step S19, the CPU 121 configures the notification threshold number based on the numbers of characters indicated by the ExtStr of the respective output formats used in the output character string extracting process of step S18 (S101). The process of step S101 is a process of a configuring step, and corresponds to the function of the threshold setting part 151.

Next, when a character string shorter than the notification threshold number was extracted in the output character extraction process (Yes in S102), the CPU 121 controls the notifying unit 132 to notify the operator that there is a possibility of misreading (S103). The process of steps S101 and S102 is a process of a notifying step, and corresponds to the function of the notification determining part 152 and the notifying part 153.

Thereafter, the CPU 121 proceeds to step S20. If No in step S102, the CPU 121 proceeds to step S20 without performing the notification.

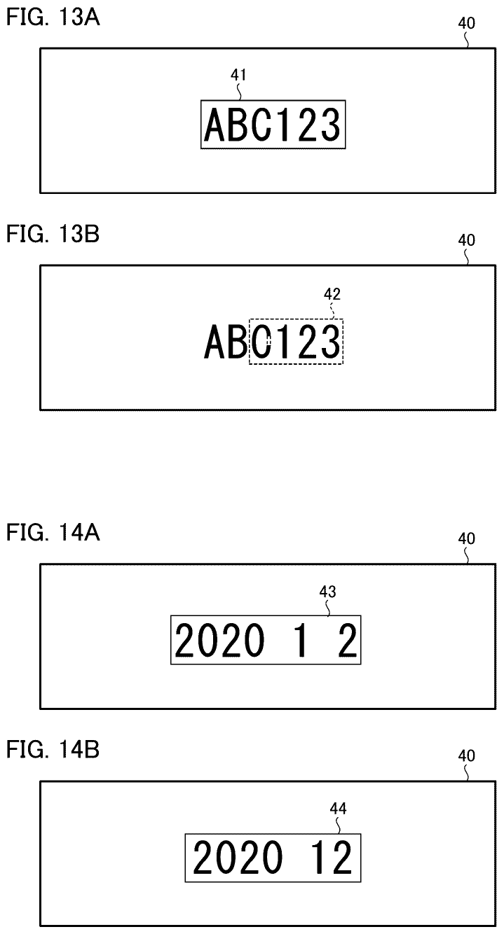

The notification of the possibility of misreading performed by the above process basically assumes a case where a plurality of output formats are effective, and notifies a possibility that a character string at a position not intended is output due to misidentification or misreading, when the output is performed in accordance with an output format having an ExtStr with smaller number of characters. However, through an appropriate configuration of the notification threshold number, notification under more complicated conditions is also possible. Next, this point will be described referring to FIG. 13A to FIG. 14B and Tables 1 to 3.

First, as an example, a case where two output formats of a format C with an ExtStr indicating “three alphabet characters +three digits” and a format D with an ExtStr indicating “four digits” will be discussed.

In this case, when an image of the character string “ABC123” arranged in the imaging area 40 as shown in FIG. 13A is captured and the character string in the image is correctly identified, the entire character string 41 matches the format C, and is extracted as an output character string. On the other hand, there is no output character string matching the format D.

On the other hand, when the image is captured so that the opening of “C” appears connected as indicated by a broken line in FIG. 13B and the character of “C” is misidentified as “0”, the character string will be recognized as “AB0123”. In this case, there is no output character string matching the format C, and the character string 42 indicated by a broken line matches the format D. Accordingly, a character string that matches the format D, which should not be there, is output due to the misidentification, resulting in misreading.

However, when a character string such as “1234” is read, a character string matching the format D is normally output, and the fact that the character string matching the format D is output cannot itself be regarded as an anomaly.

Therefore, in the second embodiment, when an output character string matching (the ExtStr of) the format D is extracted, the reading device 100 notifies the operator of the possibility that a misreading has occurred. Upon the notification, the operator can compare the actually read character string 102 with the output result of the reading to confirm whether or not the reading has been correctly performed. If the operator notices the misreading, the operator can easily reread the character string 102, or manipulate the reading device 100 or the destination data processing device to correct the read result.

Cases such as the above-described format D may typically occur when a plurality of output formats are used, and output according to the output format having an ExtStr with smaller number of characters is performed. Even when the output is performed according to the output format having an ExtStr with larger number of characters is performed, it cannot be said that the misreading will not occur at all, but the frequency is considered to be low. Such misreading will occur only in cases where, for example, in spite of trying to read four digits, a character string including characters other than the four digits such as “AB0123”, and the “0” is misidentified as “C”.

Therefore, in this embodiment, focusing on the number of characters in the extracted output character string, and when the number of the characters is less than the notification threshold number, the possibility of misreading is notified. The notification threshold number may be the number of characters of the longest ExtStr among those of the effective output formats (six characters of the format C in the above example).

When the notification is performed according to this criterion, for example, the possibility of misreading is notified even when a character string such as “1234” is read and a character string matching the format D is normally output. However, for example, in the case of a handheld-type reading device 100, it is easy for the operator to compare the actual character string 102 with the read result to check it in response to the notification, and it is not a serious problem to notify the possibility of misreading in spite of normal output. Rather, it is more important to enable to find and correct misreading in response to the notification.

Although the examples discussed above are those regarding output formats having the ExtStrs with fixed lengths, an ExtStr may indicate a character string having a variable length. For example, the ExtStr may indicate “four to six digits”.

If an output format having such an ExtStr is adopted, even when only one output format is effective, the possibility of misreading should be notified in some situations. For example, even when a character string of five digits such as “12345” is recognized and the character string is output as matching the effective output format, it is conceivable that the character string actually intended to be read is “123456”, and of these, “6” was out of the imaging area.

Accordingly, when a character string shorter than six characters, which is the maximum number of characters to be output, matches (the ExtStr of) the output format, and is adopted and extracted as the output character string, it is preferable to notify of the possibility of misreading following the same reasoning as in the case of the aforementioned format D.

Therefore, when the ExtStr indicates a character string having a variable length, the process of FIG. 11 may be performed while adopting the maximum length of the ExtStr as the notification threshold number.

In addition, in some cases, the output character string frequently becomes five characters in correct readings, and it may be preferable to perform the notification only when the output character string is four characters, for example. In this case, the notification threshold number may be five characters indicating a shorter character string than the maximum length itself.

When an ExtStr indicates a character string divided into a plurality of sections, such as the ExtStr of the output format (date format) of ID=8 in FIG. 3, the notification threshold number may be determined and configured for each section. In this case, it is conceivable that, in the decision of step S102 in FIG. 11, the output character string is compared with the notification threshold number for each section, and when the number of characters of the output character string is less than the notification threshold number in at least one section, the decision results in Yes.

For example, in the date format of FIG. 3, the maximum number of characters of the entire ExtStr is ten characters in the case of “YYYY/MM/DD” and the like. However, when viewed by sections separated by the delimiter “/”, the maximum number of characters is four in the leftmost year section, two in the middle month section, and two in the rightmost day section. These values may be adopted as the notification threshold numbers for the respective sections as they are.

However, for the year, the notation “YY” is sometimes assumed, and even when only the lower two digits of the four digits are read and the upper two digits are parted, it often causes no substantive problem. In consideration of this point, it is conceivable to adopt two characters as the notification threshold number for the year section. Then, if the year section is simply considered to be two characters, the maximum number of characters of the entire ExtStr is eight. However, in some cases, even when an output character string of the eight characters is extracted according to the entire ExtStr, it is desired to notify the possibility of misreading.

The cases are, for example, those wherein the character string 43 or the character string 44 shown in FIG. 14A and FIG. 14B is recognized in the character string recognizing process. When space characters are represented by □, the character string 43 is “2020□1□2”, and the character string 44 is “2020□12”. At least the character string 43 matches the date format, and the character string 44 also matches if DD of the date is allowed to be zero digits.

On the other hand, it may be difficult to accurately recognize the presence or absence of a space or the number of spaces depending on the angle at which the character string is imaged. Therefore, when the character strings 43 and 44 with delimiters by spaces are recognized, it is difficult to determine which is the actual character strings. That is, there is a possibility of misreading, and it is desired to notify.

However, since the number of characters of the character string 43 is eight, if the notification threshold number is eight characters for the entire ExtStr as described above, the possibility of misreading is not notified.

On the other hand, if the notification threshold number for each section is configured to be two characters/two characters/two characters, the possibility of misreading can be notified in either case where the character string 43 or 44 is output. This is because the month and the day in the character string 43 are respectively one character, and the day in the character string 44 is 0 characters, each of which is less than the notification threshold number for the corresponding section.

In this way, by determining the notification threshold number for each section of ExtStr, it is possible to more flexibly control presence or absence of the notification of the possibility of misreading.

As shown in Tables 1 to 3 below, there may be an output format in which ExtStr indicates a variable number of characters in each of plural sections. It is also possible to use output formats having ExtStrs indicating different numbers of sections at the same time. Hereinafter, a method of determining the notification threshold number that can be adopted in these cases will be described.

TABLE 1

| | |
|---|---|
| ExtStr of Output | No. 1 3 digits “—” 4 digits |
| Format | No. 2 2-3 digits “—” 3-4 digits “—” 3-4 digits |
| Maximum number | No. 1 3/4/none |
| of characters of | No. 2 3/4/4 |
| each section | |
| Example #1 of | 3/4/4 |
| notification | |
| threshold number | |
| for each section | |
| Example #2 of | 3/4/none |
| notification | |
| threshold number | |
| for each section | |

When the output formats No.1 and No.2 described in Table 1 are effective, assumed that “-” is a delimiter, the maximum number of characters in each section is as described in the second row of the table. The example #1 of the notification threshold number simply takes the maximum number of characters for each section of the ExtStrs among each output format. Since the third section does not exist in the ExtStr of the output format No. 1, the notification threshold number for the third section is considered to be zero characters.

However, if the possibility of misreading is notified according to the above notification threshold numbers, the notification will be always performed except when the character string having the maximum number of characters according to the output format No.2 is read, resulting in too frequent notification. On the other hand, if there is only one effective output format having the ExtStr with characters in the third section, the operator is expected to pay more attention on successful reading than usual when reading a character string with characters in the third section, and also expected to pay particular attention to the number of characters in the third section of the read result.

Therefore, it is not necessary to configure the notification threshold number for the third section, that is, the section in which (the ExtStr of) only one output format indicates characters. The example #2 of the notification threshold numbers is an example of this. In this case, the decision of step S102 in FIG. 11 is not performed for the third section, and the notification of the possibility of misreading is not triggered by the fact that the number of characters in the third section is small.

By this way, it is possible to keep the notification frequency within a reasonable range.

TABLE 2

| | |
|---|---|
| ExtStr of Output | No. 1 4 digits “—” 7-8 digits |
| Format | No. 2 2-3 digits “—” 3-4 digits “—” 3-4 digits |
| Maximum number | No. 1 4/8/none |
| of characters of | No. 2 3/4/4 |
| each section | |
| Example of | 4/8/none |
| notification | |
| threshold number | |
| for each section | |

In the case of Table 2, if the notification threshold number for the third section is determined to be four characters adopting the maximum number of characters among each output format, extraction of an output character string according to either of the output formats No. 1 or No. 2 will always trigger the notification of the possibility of misreading. Therefore, in the case of Table 2, the validity of not determining the notification threshold number for the third section, that is, the section where the ExtStr of only one output format indicates characters, is higher than in the case of Table 1.

TABLE 3

| | | |
|---|---|---|
| ExtStr of Output | No. 1 | 4 digits “—” 7-8 digits |
| Format | No. 2 | 2-3 digits “—” 3-4 digits “—” 3-4 digits |
| | No. 3 | 2-3 digits “—” 3-4 digits “—” 3-4 digits |
| Maximum number | No. 1 | 4/8/none |
| of characters of | No. 2 | 3/4/4 |
| each section | No. 3 | 3/4/4 |
| Example of | 4/8/4 | |
| notification | | |
| threshold number | | |
| for each section | | |

In the case of Table 3, ExtStrs of plural output formats indicate characters in all sections. Therefore, in this case, it is preferable to determine, for each section, the notification threshold number by taking the maximum number of characters of the ExtStrs among each output format. In this case, extraction of an output character string according to any of the output formats No. 1 to No. 3 will always trigger the notification of the possibility of misreading. However, the setting of the effective output formats as shown in Table 3 is likely to cause misreading, and it can be considered that the notification here appropriately reflects such situation.

As described above, the reading device 100 of this embodiment notifies the operator of the possibility of misreading when the output character string extracted by the character extracting part 144 has characters less than the notification threshold number, so that it is possible to notify the operator of the possibility of misreading at an appropriate frequency through simple process.

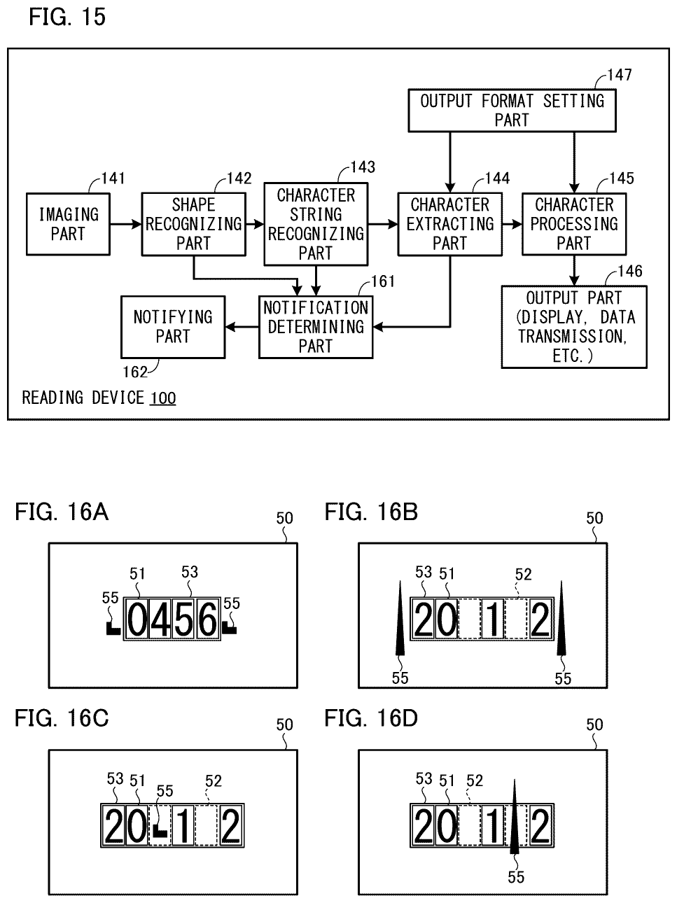

### Third Embodiment: FIG. 15 to FIG. 19D

Next, a third embodiment of the present invention will be described.

The reading device 100 of the third embodiment is different from that of the first embodiment in that a character recognition condition is not used, and that possibility of misreading is notified when there is a shape that does not constitute any character in or near the character string recognized by the character string recognition. Since the other portions are the same as those in the first embodiment, the matters related to the differences will be described, and the description of the common portions will be appropriately omitted.

First, functions related to reading of the character string 102 included in the reading device 100 of the third embodiment will be described.

FIG. 15 is a functional block diagram corresponding to FIG. 2, illustrating a configuration of the functions.

As illustrated in FIG. 15, the reading device 100 of the third embodiment includes a notification determining part 161 and a notifying part 162 in place of the character recognition condition setting part 148 of FIG. 2. Further, the character string recognizing part 143 performs character string recognition without using the character recognition condition, and this point is the same as that of the second embodiment.

The notification determining part 161 has a function of obtaining information on the shapes recognized by the shape recognizing part 142, the character string (first character string) recognized by the character string recognizing part 143, and the output character string (second character string) extracted from the first character string by the character extracting part 144, and instructing the notifying part 162 to notify of a possibility of misreading when it is determined that there is a shape that does not constitute any character inside or near the second character string based on the obtained information.

The function of the notifying part 162 is the same as that of the notifying part 153 of the second embodiment.

Here, the shape that does not constitute any character is, for example, a shape that is not included in the group detected in step S53 or recognized as not being a character in step S62 in the character string recognizing process of FIG. 6. In other words, a shape that is recognized as neither a specific character nor an indefinite character in step S57 or S61 among the shapes recognized in step S51.

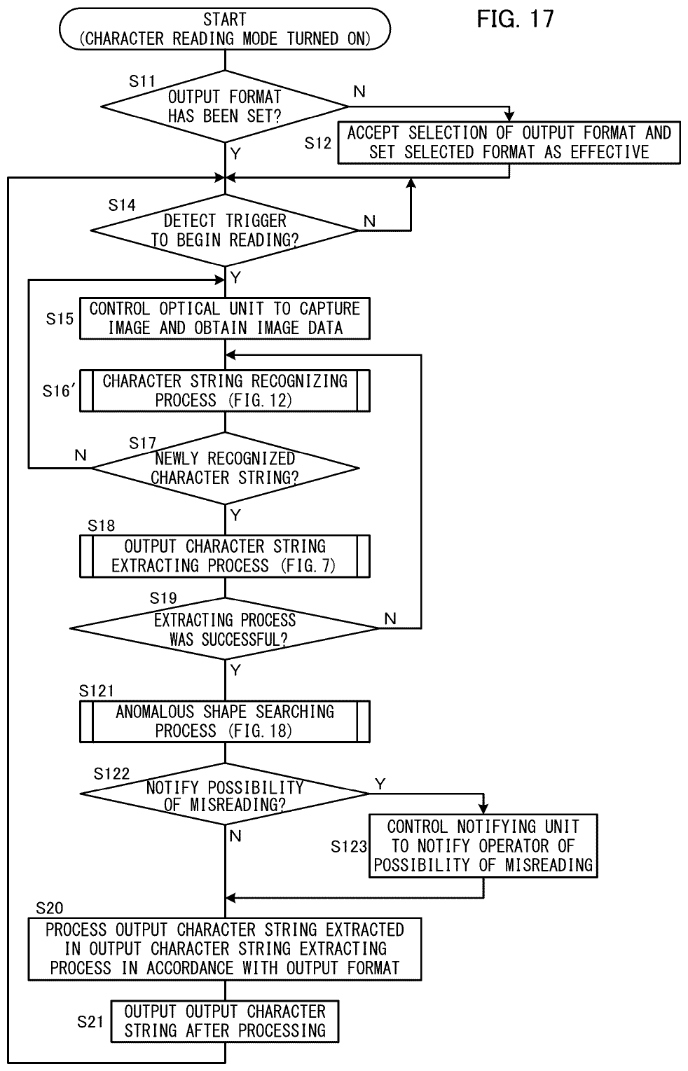

FIG. 16A to FIG. 16D show examples of such shapes that do not constitute any character.

All of FIG. 16A to FIG. 16D show examples in which a character string 53 is recognized in an image 50 captured by the imaging part 141 through the character string recognizing process, and the character string 53 is extracted as an output character string as it is. The specific characters constituting the character string 53 differ depending on the drawing. In the character string 53, individual characters 51 constituted by shapes are enclosed by solid lines including those not denoted by reference signs. The space characters 52 recognized at gaps between the characters are indicated by dashed lines.

In addition, the image 50 may include some shapes that does not constitute any character as indicated by the reference signs 55. The positions where the shapes 55 may be present and the sizes of the shapes 55 may vary. In the examples of FIG. 16A and FIG. 16B, the shapes 55 exist near the character string 53, and in the examples of FIG. 16C and FIG. 16D, the shapes 55 exist in the character string 53.

It should be noted that there is little need to distinguish whether the shape 55 is in or near the character string when notifying of the possibility of misreading. The shapes 55 that overlap even partially with the region in which shapes of the group detected in step S53 of the character string recognizing process are arranged may be considered to be in the string 53 that exists in that region.

The shapes 55 not constituting any character may occur because of dust attached to the read object 101, a pattern or a ruled line on the read object 101, a shadow or asperity formed on the read object 101, an overexposure at the time of imaging, or the like. Regardless of the cause, when there is such a shape 55 near the recognized character string 53, the following possibilities are suggested. First, the shape 55 was an obstacle to the proper recognition of the characters constituting the character string 53, resulting in misidentification or misrecognition. Second, as a result that a part of the existing character could not be recognized as a shape, the remainder of the character was recognized as a shape 55 that does not constitute any character. Third, as a result that plural characters were connected and recognized as a single shape, the shape was not recognized as any character. All of these will lead to misreading.

In particular, when there is a shape 55 that does not constitute any character in or near the output character string extracted by the character extracting part 144, there is a possibility that some misreading has occurred at a portion directly reflected in the output, and there is a high risk that the output read result is incorrect.

Therefore, in the third embodiment, when there is a shape 55 that does not constitute any character in or near the output character string extracted by the character extracting part 144, the possibility of misreading is notified so as to appropriately alert the operator.

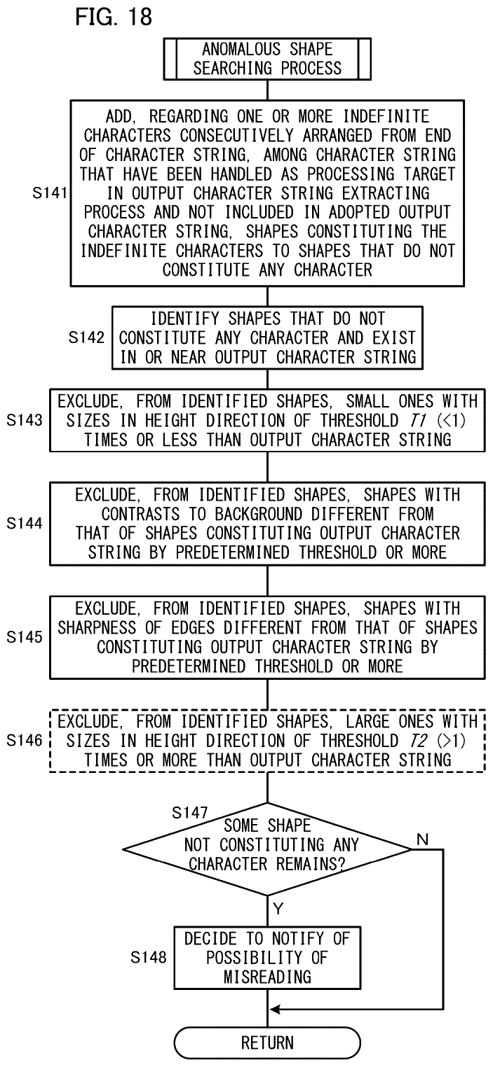

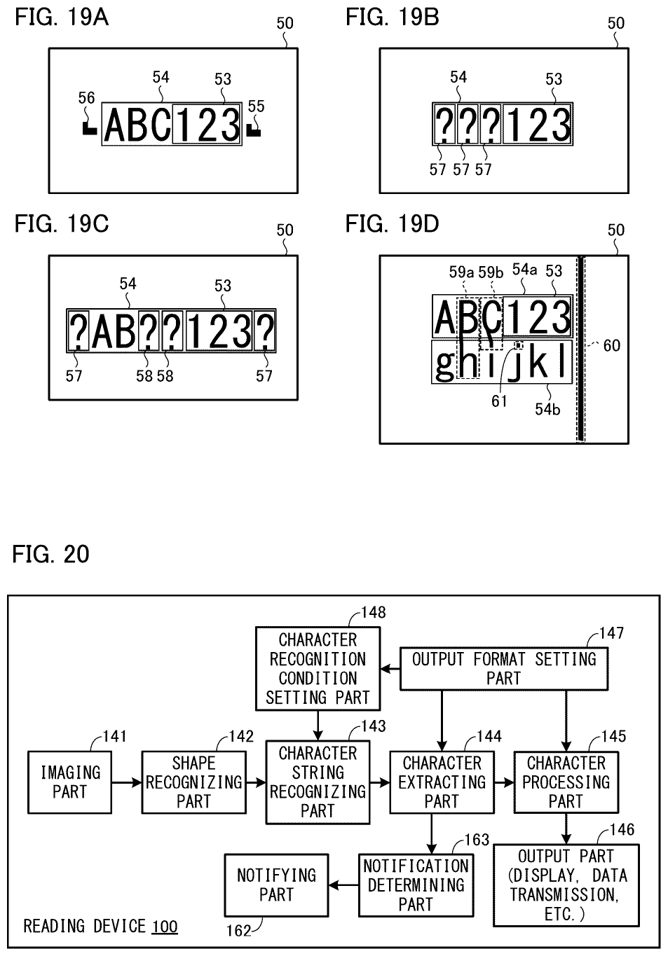

Next, processes for realizing the functions described above will be described with reference to FIG. 17 and FIG. 18, referring also to FIG. 19A to FIG. 19D. The processes described here are ones according to a third embodiment of the character string reading method of the present invention.

FIG. 17 shows a flowchart of a process corresponding to FIG. 4 executed by the CPU 121 when the character reading mode is turned on in the reading device 100.

The process of FIG. 17 differs from that of FIG. 4 only in that there is no step S13 after step S12, that step S16′ is executed instead of step S16, and that step S121 to S123 are executed prior to step S20 when Yes in step S19.

Among these, the points that there is no step S13 and step S16′ is executed instead of step S16 are the same as those in FIG. 11 described in the second embodiment.

If Yes in step S19, the CPU 121 executes an anomalous shape searching process (S121). This process is illustrated in FIG. 18, for example.

In the anomalous shape searching process of FIG. 18, the CPU 121 first adds, regarding one or more indefinite characters consecutively arranged from the end of the character string, among the character string that has been handled as a processing target in the output character string extracting process of step S18 and not included in the output character string adopted in step S89 of FIG. 7, shapes constituting the one or more indefinite characters to shapes that do not constitute any character (S141).

The shapes constituting indefinite characters are basically considered to be shapes constituting some character. In particular, the indefinite characters recognized at a position sandwiched between the identified characters such as ones indicated by the reference signs 58 in FIG. 19C are likely to be some characters that constitute a character string including the identified characters, even if the indefinite characters could not be identified as specific characters.

On the other hand, it is assumed that the indefinite characters recognized at the end of the character string such as ones indicated by the reference signs 57 in FIG. 19B may not constitute any character string including the identified characters, as compared to the case with the indefinite characters indicated by the reference signs 58. The possibility that a garbage, a pattern, or the like happened to match the size of the characters and was therefore recognized as the indefinite character cannot be ignored. This applies not only to the end of the string, but also to all indefinite characters that consecutively arranged from the end and are not sandwiched between the identified characters. The three indefinite characters from the left indicated by the reference signs 57 in FIG. 19B correspond to this.

Therefore, in the process of FIG. 18, existence of shapes is determined assuming that such indefinite characters are shapes that do not substantially constitute any character. At this time, in a case where some indefinite character is composed of plural shapes, the subsequent steps may be executed while treating each of the plural shapes as different shapes. Alternatively, the whole plural shapes may be treated as one shape. Both are conceivable.

However, when an indefinite character is indicated included by the ExtStr of the effective output format, the extracted output character string will include the indefinite character. It is considered that the indefinite character included in the output character string is a character that is expected to exist, and is not recognized as a result of misidentification or misreading. Therefore, in step S141, shapes constituting such an indefinite character is not included in the shapes not constituting any character.

Next, the CPU 121 identifies the shapes that do not constitute any character and exist in or near the output character string (S142). For example, it is conceivable to identify the shapes that are at least partially within a predetermined distance from any character in the character string as shapes in or near the character string. It is also conceivable to determine the distance at which the influence of the shapes on the character recognition regarding the output character string cannot be ignored, based on experiments and empirical rules, to use the determined value as the predetermined distance. For example, it is conceivable to determine the predetermined distance based on the maximum interval between the characters in the character string to be read as a reference. The need to distinguish between the “in” and “near” is low, as described above.

Thereafter, the CPU 121 excludes, from the shapes identified in step S142, small ones with sizes in the height direction (the direction of the arrow h in FIG. 8) of threshold T1 (<1) times or less the size h of the output character string (S143). The size in the height direction here is the size in the height direction of the output character string.

It is considered that shapes with sizes smaller than that of a point constituting a character as indicated by the reference sign 61 in FIG. 19D will cause only minor effects on character recognition even if the shapes do not constitute any character, and therefore, it is preferable to determine T1 so as to exclude at least such shapes. In addition, it is conceivable to determine T1 so that the threshold becomes a size smaller than the smallest point included in characters, in accordance with the font or the like of the characters to be read. Alternatively, T1 may be ½. A value of ⅓ or the like, which is slightly smaller, may be adopted with some margin.

Further, the CPU 121 excludes, from the shapes identified in step S142, shapes with contrasts to the background or sharpness of the edges different from that of the shapes constituting the output character string by a predetermined threshold or more (S144, S145).

When these features of the shapes differ greatly from those of the shapes constituting the characters, it is considered that the shapes will cause only minor effects on character recognition. Further, there is nothing particularly odd about it, even if such shapes are classified as shapes other than the characters. Accordingly, the shapes corresponding to the above are excluded. Each threshold value may be determined based on how much the contrast or the edge sharpness must differ before the impact on the character recognition becomes negligible.

Thereafter, the CPU 121 may exclude, from the shapes identified in step S142, large ones with sizes in the height direction of threshold T2 (>1) times or more the size h of the output character string (S146). The size in the height direction here is the size in the height direction of the output character string.

A shape with a large size in the height direction may be one indicated by the reference sign 59a or 59b in FIG. 19D that occurred by recognizing plural characters as one shape in a connected state. For example, the plural characters are ones adjacent to each other in the height direction in plural character strings located in close proximity in the height direction as indicated by the reference signs 54a and 54b. When such a shape exists, misreading is likely to have occurred.

On the other hand, a shape assumed to be obtained by recognizing ruled lines or patterns as indicated by the reference sign 60 is also conceivable. It is considered that such a shape is more likely to cause misidentification or misreading than the shapes 59a and 59b if it is near some character.

However, for example, in a case where the read object 101 has a line pattern or a mesh pattern, if shapes like one indicated by the reference sign 60 is adopted as triggers for the notification of the possibility of misreading, the notification will be performed very frequently. In such a case, it is conceivable to keep the frequency of the notification within a reasonable range by excluding the large shapes.

The value of 72 used in this case may be, for example, two. This is because it is considered that three or more characters are hardly recognized in a connected state, and the sizes of the shapes indicated by the reference signs 59a and 59b are considered to be approximately twice or less the height of the character string.

It should be noted that the operator may be allowed to arbitrarily set whether or not the large shapes are to be triggers of the notification, that is, whether or not to execute step S146. This also applies to each of steps S143 to S145.

In any case, the CPU 121 decides to notify of the possibility of misreading (S148) if some shape identified in step S142 remains until step S147, and returns to the original process. If no shapes remain until step S147, the CPU 121 returns to the original process without deciding the notification.

Returning to FIG. 17, after the anomalous shape searching process in FIG. 18, when having decided to notify the possibility of misreading in the process of FIG. 18 (Yes in S122), the CPU 121 controls the notifying unit 132 to notify the operator of the possibility of misreading (S123).

Thereafter, the CPU 121 proceeds to step S20. If No in step $122, the CPU 121 proceeds to step S20 without performing the notification.

The process of steps S121 to S123 is a process of a notifying step, and corresponds to the functions of the notification determining part 161 and the notifying part 162.

By the above process, when a possibility of misreading is recognized based on the result of the shape recognition and the character string recognition, the possibility can be appropriately notified to the operator.

In the process described here, the notification is performed when there is a shape that does not constitute any character in or near the output character string extracted in the output character string extracting process. However, even when there is a shape that does not constitute any character in or near the character string recognized in the character string recognizing process, the notification may be performed.

This is because, although the character string finally reflected in the output is the output character string, the output character string cannot be properly extracted if misidentification of characters occurs at the time of the character string recognizing process in the character string recognizing part 143 even at a place other than the output character string, and the final output may also be incorrect.

For example, consider the case where the reference sign 54 in FIG. 19A indicates a character string recognized in the character string recognizing process and the reference sign 53 indicates an output character string extracted therefrom. In this case, when considering only the interior or vicinity of the output character string 53, only the shape 55 is a shape that exists in or near the character string and does not constitute any character. However, when considering the interior or vicinity of the character string 54, the shape 56 in addition to the shape 55 corresponds to a shape that exists in or near the character string and does not constitute any character.

Even when a shape that does not constitute any character exists in this range, the possibility of misreading may be notified.

Note that some or all of the processes of steps S143 to S146 in FIG. 18 may be omitted. Even shapes excluded in steps S143 to S146 may affect the character recognition a little, and thus may be used as triggers of the notification of the possibility of misreading.

In addition, if an indefinite character at an end of some character string is always treated as “shape that does not constitute any character”, the notification of the possibility of misreading may occur too frequently. Therefore, for example, indefinite characters may be treated as a shape constituting some character, except for the case where the indefinite character is likely to be a shape that occurred by recognizing plural adjacent characters in a connected state as indicated by the reference signs 59a and 59b in FIG. 19D. For example, it is conceivable to treat an indefinite character as a shape constituting some character, when the size of the indefinite character in the height direction is substantially equal to the size of characters constituting a character string (when the size difference is a predetermined threshold value or less).

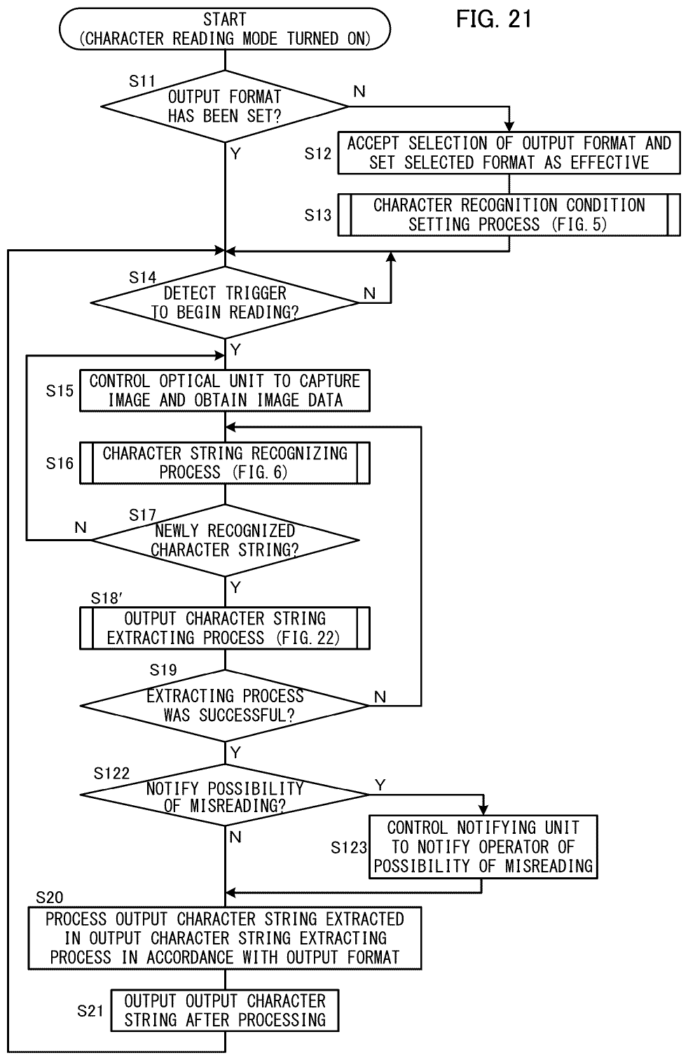

### Fourth Embodiment: FIG. 20 to FIG. 22

Next, a fourth embodiment of the present invention will be described.

The reading device 100 of the fourth embodiment is different from that of the first embodiment in that the possibility of misreading is notified when there are a plurality of items in the candidate list at a certain stage during the output character string extracting process. Since the other points are the same as those in the first embodiment, the matters related to the differences will be described, and the description of the common points will be appropriately omitted.

First, functions related to reading of the character string 102 included in the reading device 100 of the fourth embodiment will be described.

FIG. 20 is a functional block diagram corresponding to FIG. 2, illustrating a configuration of the functions.

As illustrated in FIG. 20, the reading device 100 of the fourth embodiment includes a notification determining part 163 and a notifying part 162 in addition to the configuration illustrated in FIG. 2.

The notification determining part 163 has a function of receiving, from the character extracting part 144, information indicating whether or not the notification of the possibility of misreading is necessary, and instructing the notifying part 162 to notify of the possibility of misreading when the notification is necessary. The function of the notifying part 162 is the same as that of the third embodiment.

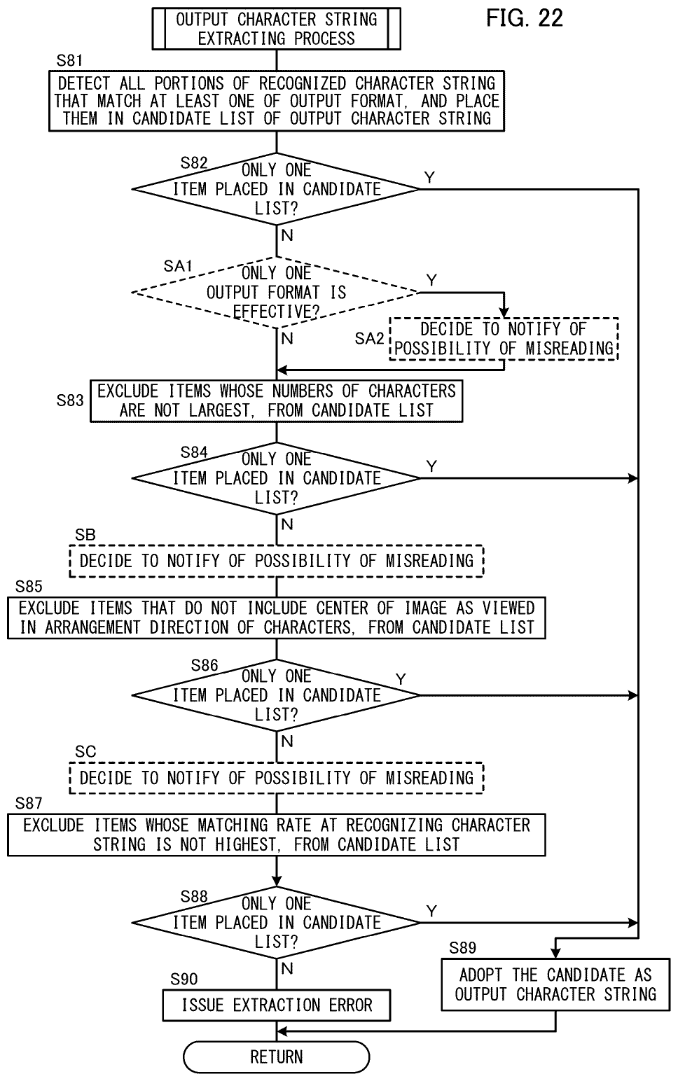

Next, processes for realizing the functions described above will be described with reference to FIG. 21 and FIG. 22. The processes described here are ones according to a fourth embodiment of the character string reading method of the present invention.

FIG. 21 shows a flowchart of a process corresponding to FIG. 4 executed by the CPU 121 when the character reading mode is turned on in the reading device 100.

The process of FIG. 21 differs from that of FIG. 4 only in that step S18′ is executed instead of step S18, and that steps S122 and S123 are executed prior to step S20 when Yes in step S19.

The output character string extracting process of step S18′ is shown in FIG. 22, for example. In this process, steps SA1, SA2, SB, and SC indicated by broken lines are added to the process of FIG. 7.

Among them, step SB is a process of deciding to notify of the possibility of misreading when failing to narrow down candidates of the output character string to one based on the numbers of the characters, and attempting to narrow down the candidates based on the criterion whether or not the candidate includes the center of the image. Similarly, step SC is a process of deciding to notify of the possibility of misreading when attempting to narrow down the candidates based on the criterion of the matching rate.

As described with reference to FIG. 9B and 9C in the first embodiment, when misidentification or misreading occurs, it is often necessary to narrow down the candidates to one based on these criteria. Further, even if the character string recognition was accurate, when the candidates are narrowed down based on whether or not the center of the image is included or on the basis of the matching rate, it is relatively variable which of the plural candidates is adopted as the output string. Therefore, it can be said that the possibility that the output character string different from the operator's intention is obtained cannot be ignored in this situation.

Steps SB and SC are implemented to notify the operator of the possibility of misreading in such cases to facilitate detailed review of the read results.

Further, steps SA1 and SA2 are processes of deciding to notify of the possibility of misreading when plural candidates are detected in step S81 even though only one output format is effective.

When a plurality of output formats are effective, it is often assumed that candidates for the output character string are detected for each of the effective output formats as in the reading of the upper character string described in FIG. 9A, and then narrowed down to one based on the criterion of the number of characters. However, when plural candidates are detected in step S81 in spite of the only one effective output format, the possibility that this happened due to misidentification, misreading or other unexpected circumstances as explained in the examples shown in FIG. 9B and Fig, 9C cannot be ignored.

Steps SA1 and SA2 are implemented to notify the operator of the possibility of misreading in such cases to facilitate detailed review of the read results.

The above steps SA1 and SA2, step SB, and step SC may be adopted solely or in any combination.

Further, the processes of step S122 and S123 in FIG. 21 are the similar to those of step S122 and S123 in FIG. 17, and differ only in that whether or not to notify of the possibility of misreading is decided based on whether or not the notification is decided in the process of step S18′ shown in FIG. 22.

By the above-described process, it is possible to appropriately notify the possibility of misreading, when the possibility is recognized based on the detection state of the candidates of the output character string or the state of the narrowing down thereof.

Note that, at the start of the process of FIG. 22, it is not necessary to reset the decision to notify of the possibility of misreading that has been made in the past. When an extraction error occurs, there is a case where the process of FIG. 22 is performed again on the next recognized character string as a processing target. It is considered that misidentification or misreading is likely to occur also in such situation, and therefore, even when the candidates of the output character string are narrowed down to one at the stage of step S82 in the second or some subsequent trials of the process of FIG. 22, it is useful to notify of the possibility of misreading.

However, this is not essential, and the decision to perform the notification may be reset at the start of the process of FIG. 22. Anyway, after the notification is performed in step S123, the decision to perform the notification is reset.

Further, the process of FIG. 21 includes step S13, and thus the character recognition condition is used in the fourth embodiment. However, this is not essential. It is not necessary to use the character recognition condition, as in the second and third embodiments. That is, step S13 may be omitted, and the character string recognizing process shown in FIG. 12 may be performed in step S16′, instead of step S16.

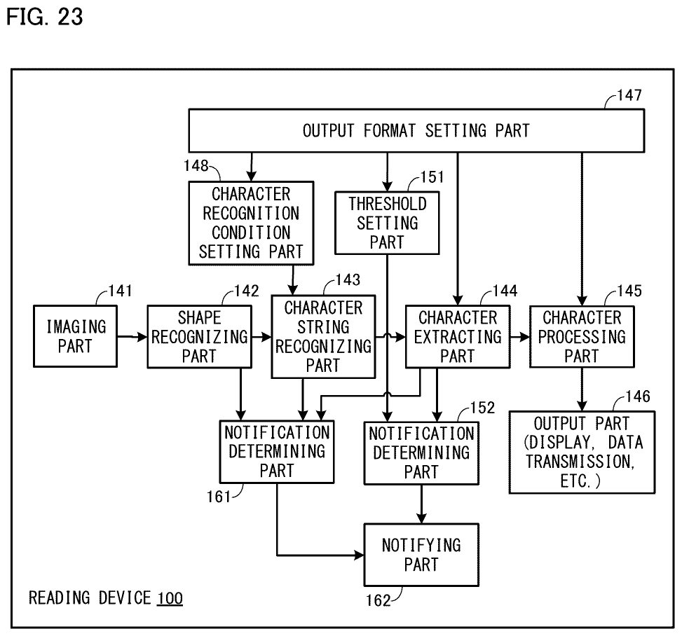

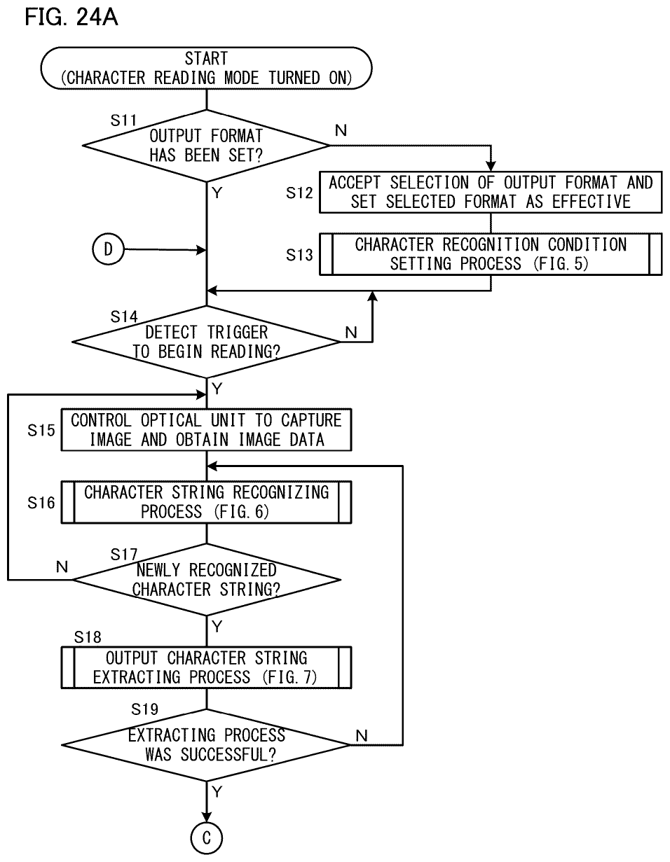

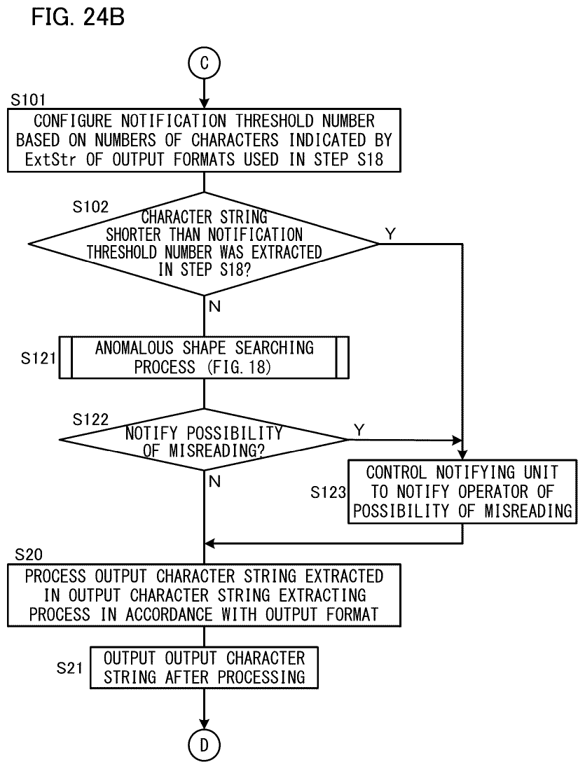

### Fifth Embodiment: FIG. 23 to FIG. 24B

Next, a fifth embodiment of the present invention will be described. The reading device 100 of the fifth embodiment has a combination of the functions of: character string recognition using the character recognition condition; notification of a possibility of misreading based on the number of characters of the output character string extracted by the character extracting part 144; and notification of a possibility of misreading when a shape that does not constitute any character exists in or near the output character string, which have been described in the first to third embodiments. Therefore, the description will be made referring to each embodiment.

First, functions related to reading of the character string 102 included in the reading device 100 of the fifth embodiment will be described.

FIG. 23 is a functional block diagram corresponding to FIG. 2, illustrating a configuration of the functions.

As illustrated in FIG. 23, the reading device 100 of the fifth embodiment includes, in addition to the respective parts illustrated in FIG. 2, the threshold setting part 151 and the notification determining part 152 illustrated in FIG. 10, and the notification determining part 161 and the notifying part 162 illustrated in FIG. 15. Since the functions of the respective parts are the same as those illustrated in the previous drawings, detailed description thereof will be omitted. The function of the notifying part 153 in FIG. 10 can be realized by the notifying part 162.

Next, processes for realizing the above-described functions will be described with reference to FIG. 24A and FIG. 24B. The processes described here are ones according to a fifth embodiment of the character string reading method of the present invention.

FIG. 24A and FIG. 24B show a flowchart of a process corresponding to FIG. 4 executed by the CPU 121 when the character reading mode is turned on in the reading device 100.

In the process of FIG. 24A and FIG. 24B, although divided into two figures, steps S101 to S103 similar to those in FIG. 11 are added to the process of

FIG. 4 (step S123 is the same as step S103), and in the case of No in step S102, steps S121 to S123 similar to those in FIG. 17 are added.

By performing the processes described above, all the functions described in the first to third embodiments can be realized, and all the effects of these functions can be realized.

Further, by performing the process of FIG. 22 as the output character string extracting process of step S18, the functions of the fourth embodiment can also be combined to realize the effects thereof.

Further, for example, the following effects can be additionally obtained by combining the use of the character recognition condition according to the first embodiment and the notification of the possibility of misreading in a case where there is a shape not constituting any character in or near the recognized character string according to the third embodiment.

First, consider a case where an output format with an ExtStr indicating “four digits” is set to be effective with the intention of reading a character string constituted of four digits only. At this time, the character string “BOOING” does not match the ExtStr of the output format if it is correctly identified. However, if, for example, the portion of “BOOI” is erroneously recognized as “8001”, the character string is recognized as “8001NG”, and the portion “8001” matches the output format, and is extracted as the output character string, resulting in misreading. If there is no other shape that does not constitute any character, the possibility of misreading is not notified.

Here, if “digits only” is defined as the character recognition condition, the character string is recognized as “8001??” even in the case where the above-described erroneous recognition occurs. In this case, there are indefinite characters that are recognized as shapes that do not constitute any character next to “8001” to be the output character string, and thus the possibility of misreading can be notified and the operator can be alerted.

That is, by appropriately setting the character recognition condition and thereby preventing recognition of a character that is not necessary for reading, in a case where a portion matching the ExtStr of the output format occurs due to unintended erroneous recognition, the possibility that an indefinite character exists in the vicinity of the portion can be increased, and thereby enabling more meaningful use of the function of notifying the possibility of misreading because of the shapes that does not constitute any character.

### Modifications

Although the description of the embodiment has been completed above, in the present invention, the specific configuration of the device, the specific procedure of the process, the format of the data including the output format, the contents of the specific data and the character strings, the types of the characters to be handled, and the like are not limited to those described in the embodiment.

For example, even when reading non-English alphabet characters, Hiragana, Katakana, or Kanji characters in Japanese, or the like, the functions of the above-described embodiments can be adopted in the same manner.

Further, in the fifth embodiment, the reading device 100 having all the functions described in the first, second, and third embodiments has been described, but the reading device 100 having the functions of any two of these embodiments can be similarly configured.

Further, it is not obstructed to dispose the functions of the reading device 100 of the above-described embodiments in a distributed manner among a plurality of devices, or to dispose a part of the functions illustrated in FIG. 2 or the like in the destination data processing device, for example.

In addition, it is not essential to obtain the image of the read object 101 by imaging. The above-described embodiment can be applied to a case where an image is obtained by scanning using a flatbed scanner, a handy scanner that slides on an object to be read by hand, or the like, and a case where an image is obtained by any other method.

Further, an embodiment of a computer program of the present invention is a computer program for causing one computer or a plurality of computers to cooperate to control required hardware, to realize the functions of the reading device 100 in the embodiments described above, or to execute the processes described in the embodiments above.

Such a computer program may be stored in a ROM or another non-volatile storage medium (flash memory, EEPROM, or the like) originally included in the computer. The program can be provided while being recorded on an arbitrary non-volatile recording medium such as a memory card, a CD, a DVD, a Blu-ray Disc or the like. The computer program can also be downloaded from an external device connected to a network, and installed into and executed by the computer.

Further, the configurations of the above-explained embodiments and modified examples can be embodied in an arbitrary combination unless they are inconsistent with one another and, as a matter of course, can be embodied while taking out only parts of them.

### REFERENCE LIST

40 . . . imaging area
50 . . . image
100 . . . reading device
101 . . . read object
102 . . . character string
110 . . . optical unit
111 . . . imaging sensor
112 . . . lens
113 . . . pulsed LED
120 . . . controller
131 . . . operation unit
132 . . . notifying unit
133 . . . display unit
141 . . . imaging part
142 . . . shape recognizing part
143 . . . character string recognizing part
144 . . . character extracting part
145 . . . character processing part
146 . . . output part
151 . . . threshold setting part
152 and 161 . . . notification determining part
153 and 162 . . . notifying part

1. A character string reading method capable of being executed by a character string reading device, comprising:
obtaining a first image of a read object by an image obtaining part;
obtaining a first format of a character string to be read from the first image and to be output;
setting, as a first character recognition condition, that only a first group of characters including all characters defined by the first format are to be identified, among characters which the character string reading device can identify;
recognizing a first character string in the first image according to the first character recognition condition; and
obtaining, for output, a second character string at a portion matching the first format among the first character string.

2. The character string reading method according to claim 1,
wherein the recognizing of the first character string comprises:
recognizing first shapes included in the first image;
specifying a character candidate constituted by a combination of one or more shapes among the first shapes;
identifying which character the character candidate is, based on a matching rate obtained by comparing characteristics of the specified character candidate with characteristics of each of the characters in the first group, and recognizing a character candidate which is not identified as any of the characters in the first group as an indefinite character; and
recognizing the identified character and the indefinite character being arranged in a substantially straight line, as the first character string constituted of the arranged identified character and indefinite character.

3. The character string reading method according to claim 1,
wherein in the obtaining of the second character string, in a case where a plurality of portions matching the first format are found in the first character string, a first portion with a highest matching rate with characteristics of characters in the recognizing of the first character string, among the plurality of portions, is obtained as the second character string.

4. The character string reading method according to claim 3,
the method further comprising:
notifying a possibility of misreading in the case where the plurality of portions matching the first format are found in the first character string.

5. The character string reading method according to claim 1,
wherein in the obtaining of the second character string, in a case where a plurality of portions matching the first format are found in the first character string, a first portion including a center of the first image viewed in a direction of arrangement of characters in the first character string, among the plurality of portions, is obtained as the second character string.

6. The character string reading method according to claim 5,
the method further comprising:
notifying a possibility of misreading in the case where the plurality of portions matching the first format are found in the first character string.

7. The character string reading method according to claim 1, wherein
a plurality of first formats are obtained in the obtaining of the first format,
the first group of characters regarding the first character recognition condition includes all characters defined by at least one format of the plurality of first formats, and
the obtaining of the second character string comprises:
obtaining a portion matching at least one format of the plurality of first formats among the first character string as a candidate of the second character string.

8. The character string reading method according to claim 7,
wherein the obtaining of the second character string comprises:
obtaining, among the obtained candidates of the second character string, a first candidate that matched the first format over a longest number of characters as the second character string.

9. The character string reading method according to claim 1, wherein
the first format can include a processing rule of a character string, and
the method further comprising:
processing, in a case where the first format includes the processing rule, the second character string according to the processing rule, and outputting the processed character string.

10. A character string reading device, comprising:
an image obtaining part configured to obtain a first image of a read object;
a format obtaining part configured to obtain a first format of a character string to be read from the first image and to be output;
a character recognition condition setting part configured to set, as a first character recognition condition, that only a first group of characters including all characters defined by the first format are to be identified, among characters which the character string reading device can identify;
a character string recognizing part configured to recognize a first character string in the first image according to the first character recognition condition; and
a character string obtaining part configured to obtain, for output, a second character string at a portion matching the first format among the first character string.

11. The character string reading device according to claim 10, wherein
the character string recognizing part comprises:
a shape recognizing part configured to recognize first shapes included in the first image;
a character candidate specifying part configured to specify a character candidate constituted by a combination of one or more shapes among the first shapes; and
a character identifying part configured to identify which character the character candidate is, based on a matching rate obtained by comparing characteristics of the specified character candidate with characteristics of each of the characters in the first group, and recognize a character candidate which is not identified as any of the characters in the first group as an indefinite character, and
the character string recognizing part is configured to recognize the identified character and the indefinite character being arranged in a substantially straight line, as the first character string constituted of the arranged identified character and indefinite character.

12. The character string reading device according to claim 10,
wherein the character string obtaining part is configured to, in a case where a plurality of portions matching the first format are found in the first character string, obtain a first portion with a highest matching rate with characteristics of characters in recognition of the first character string by the character string recognizing part, among the plurality of portions, as the second character string.

13. The character string reading device according to claim 12, further comprising:
a notifying part configured to notify a possibility of misreading in the case where the plurality of portions matching the first format are found in the first character string.

14. The character string reading device according to claim 10,
wherein the character string obtaining part is configured to, in a case where a plurality of portions matching the first format are found in the first character string, obtain a first portion including a center of the first image viewed in a direction of arrangement of characters in the first character string, among the plurality of portions, as the second character string.

15. The character string reading device according to claim 14, further comprising:
a notifying part configured to notify a possibility of misreading in the case where the plurality of portions matching the first format are found in the first character string.

16. The character string reading device according to claim 10,
wherein the format obtaining part is configured to obtain a plurality of first formats,
the first group of characters regarding the first character recognition condition includes all characters defined by at least one format of the plurality of first formats, and
the character string obtaining part is configured to obtain a portion matching at least one format of the plurality of first formats among the first character string as a candidate of the second character string.

17. The character string reading device according to claim 16,
wherein the character string obtaining part is configured to obtain, among the obtained candidates of the second character string, a first candidate that matched the first format over a longest number of characters as the second character string.

18. The character string reading device according to claim 10, wherein
the first format can include a processing rule of a character string, and
the character string reading device further comprising:
an output part configured to process, in a case where the first format includes the processing rule, the second character string according to the processing rule, and output the processed character string.

19. A non-transitory machine-readable storage medium containing program instructions executable by a computer, and when executed, causing one computer or a plurality of computers in cooperation to control a character string reading device and execute a character string reading method, the character string reading method comprising:
obtaining a first image of a read object by an image obtaining part;
obtaining a first format of a character string to be read from the first image and to be output;
setting, as a first character recognition condition, that only a first group of characters including all characters defined by the first format are to be identified, among characters which the character string reading device can identify;
recognizing a first character string in the first image according to the first character recognition condition; and
obtaining, for output, a second character string at a portion matching the first format among the first character string.
